(19) United States
(12) Patent Application Publication
(10) Pub. No.: US 2023/0385965 A1
(43) Pub. Date: Nov. 30, 2023

(54) SYSTEMS AND METHODS FOR TOKENIZED REAL ESTATE

(71) Applicant: RealToken Technologies Inc., Boca Raton, FL (US)

(72) Inventors: Jean-Marc Jacobson, Deauville (FR); Remy Jacobson, Delray Beach, FL (US)

(21) Appl. No.: 18/203,572

(22) Filed: May 30, 2023

Related U.S. Application Data
(60) Provisional application No. 63/346,619, filed on May 27, 2022.
(60) Provisional application No. 63/408,027, filed on Sep. 19, 2022.

(51) Int. Cl. G06Q 50/16; G06Q 20/38; G06Q 20/36; G06Q 40/08

(52) U.S. Cl. CPC G06Q 50/167; G06Q 20/389; G06Q 20/3672; G06Q 40/08; G06Q 30/0645

(57) ABSTRACT

A property tokenization system comprising a first blockchain network having a first blockchain and a first smart contract, a tokenized real estate platform for tokenizing property to generate a plurality of ownership tokens in the property, a plurality of user devices, and a plurality of digital wallets associated with one or more of the plurality of user devices, the tokenized real estate platform, or the first blockchain network. The plurality of digital wallets is configured for receiving and storing one or more of the plurality of ownership tokens.

### RELATED APPLICATIONS

The present application claims priority to U.S. provisional patent application Ser. No. 63/346,619, filed on May 27, 2022, and entitled System and Methods For Tokenized Real Estate, and also claims priority to U.S. provisional patent application Ser. No. 63/408,027, filed on Sep. 19, 2022, and entitled Systems and Methods For Tokenized Real Estate, the contents of which are herein incorporated by reference.

### BACKGROUND OF THE INVENTION

The present disclosure generally relates to blockchain technology, and more particularly to systems and methods for tokenized real estate.

Blockchain technology has been applied to several different technological areas over the past several years in order to improve those areas. One of the improvements includes the tokenization of assets. By tokenizing an asset, a user that holding a cryptographically secured token in a cryptographic wallet can control certain aspects of the tokenized asset. However, for various technological reasons, one of the areas that has faced difficulty regarding tokenization is real estate.

What is needed, then, are systems and methods for tokenized real estate.

### SUMMARY OF THE INVENTION

This Brief Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect of the present invention is a computer-implemented property tokenization system that includes a computer processor and a data storage device configured to store a copy of a blockchain of a blockchain network. The system can also include a non-transitory computer-readable storage medium including a plurality of executable instructions. The computer processor can be configured to execute the plurality of executable instructions to generate an ownership token and then transfer, via a first blockchain transaction of a blockchain network, the ownership token to a first digital wallet, and in response to the presence of the ownership token in the first digital wallet, transfer, via a second blockchain transaction generated by a smart contract, an amount of cryptocurrency to the first digital wallet.

Another aspect of the present invention is a computer-implemented method for tokenizing property. The method can include, under control of one or more computing devices executing computer-readable instructions, tokenizing property, such as real estate or securities, into a plurality of ownership tokens by generating on a blockchain of a blockchain network the plurality of ownership tokens, and then transferring, via a first blockchain transaction of the blockchain network, a first ownership token of the plurality of ownership tokens to a first digital wallet, and in response to the presence of the first ownership token in the first digital wallet, transferring, via a second blockchain transaction generated by a smart contract, a first amount of cryptocurrency to the first digital wallet.

Another aspect of the present invention includes another computer-implemented method. The method can include, under control of one or more computing devices executing computer-readable instructions, maintaining a copy of a blockchain of a blockchain network. The blockchain can include a plurality of blocks. Each block of the plurality of blocks can include one or more blockchain transactions. The method can include tokenizing property, such as real estate or securities, into a plurality of ownership tokens by generating, on the blockchain copy, the plurality of ownership tokens, synchronizing the blockchain copy with the blockchain network via a consensus mechanism of the blockchain network, transferring, via a first blockchain transaction of the blockchain network, an ownership token of the plurality of ownership tokens to a first digital wallet, and in response to (i) the presence of the ownership token in the first digital wallet, and (ii) the addition of a block to the plurality of blocks of the blockchain copy, transferring, via a second blockchain transaction generated by a smart contract, an amount of cryptocurrency to the first digital wallet.

The systems and methods disclosed herein can reduce transaction costs associated with real estate transactions, decentralize real estate information, reduce the amount of currency needed to invest in real estate, or cause real estate to be more liquid. Numerous other objects, advantages and features of the present disclosure will be readily apparent to those of skill in the art upon a review of the following drawings and description of various embodiments.

The present invention is directed to a property tokenization system comprising a first blockchain network having a first blockchain and a first smart contract, a tokenized real estate platform for tokenizing property to generate a plurality of ownership tokens in the property, a plurality of user devices, and a plurality of digital wallets associated with one or more of the plurality of user devices, the tokenized real estate platform, or the first blockchain network, wherein the plurality of digital wallets are configured for receiving and storing one or more of the plurality of ownership tokens. The plurality of ownership tokens can correspond to a real estate asset and can comprise a Ethereum Request for Comments 20 (ERC-20) compliant token. The plurality of ownership tokens can include data restricting transfer of each of the plurality of ownership tokens to a predetermined user or a user in a predetermined jurisdiction.

The tokenized real estate platform can be configured to receive and distribute rental income associated with the property in the form of cryptocurrency to a user after an elapse of a predetermined amount of time in proportion to an amount of ownership tokens owned by the user.

The tokenized real estate platform can be configured to receive and distribute rental income generated by the property in the form of cryptocurrency. The tokenized real estate platform can include a second blockchain network having a second blockchain and a second smart contract that is configured for storing the plurality of ownership tokens and the rental income generated by the property associated with the plurality of ownership tokens, and a cross-chain network for facilitating communication between the first blockchain network and the second blockchain network. The tokenized real estate platform can also include a first liquidity pool for aggregating and storing assets from a plurality of users, a property vault for storing one or more of the plurality of ownership tokens via the second smart contract, and a rent vault for storing the rental income. The tokenized real estate platform can optionally include a token vault for identifying the holders of the plurality of ownership tokens via the second smart contract or for storing additional ones of the plurality of ownership tokens. The system can also include an off-chain network that communicates with the second smart contract of the second blockchain network to securely access data and services external to the second blockchain network. The off-chain network can include a network oof or one or more external digital agents for collecting and verifying data from various external data sources.

Further, the tokenized real estate platform can include an operations layer for managing selected financial and insurance operations between one or more of the plurality of user devices and the tokenized real estate platform associated with the first blockchain network, and an insurance liquidity pool for aggregating funds for rental insurance and an investment liquidity pool for aggregating funds for investment. The funds can be exchanged between the insurance liquidity pool and the investment liquidity pool. The insurance liquidity pool can include a low-risk reserve pool and a high-risk reserve pool and the rental insurance funds can be selectively distributed therebetween based on one or more risk related attributes. The investment liquidity pool can include a low-risk investment pool and a high-risk investment pool and the rental insurance funds can be selectively distributed therebetween based on one or more selected investment attributes.

The operations layer can include a pricing model unit for applying one or more actuarial based pricing models to user provided insurance data to determine a cost of insurance based on a plurality of insurance related factors, a loss assessment unit for determining a risk level of each of a plurality of portfolios of insurance products forming part of the insurance liquidity pool, and a risk scoring unit for determining a risk score for each of the plurality of portfolios of insurance products. The risk scoring unit can employ an Aggregate Loss Distribution (ALD) model to estimate an expected loss in each of the plurality of portfolios of insurance products. The ALD model can include a frequency model for estimating a number of claims associated with the plurality of portfolios of insurance products that occur over a selected period of time based on one or more claim related factors, and a severity model for estimating a monetary size of the claim by considering one or more loss related factors. The system of the present invention can also include a second blockchain network having a second blockchain and a second smart contract that is configured for storing the plurality of ownership tokens and the rental income generated by the property associated with the plurality of ownership tokens; a cross-chain network for facilitating communication between the first blockchain network and the second blockchain network; and an off-chain network that communicates with the second smart contract of the second blockchain network to securely access data and services external to the second blockchain network, wherein the off-chain network includes a network of external digital agents for collecting and verifying data from various external data sources.

The property tokenization system of the present can also include a model layer that communicates with the tokenized real estate platform and with the first blockchain network to apply one or more modeling techniques to information stored in the tokenized real estate platform, and a governance unit that communicates with the operations layer to allow the users to perform one or more governance related activities.

According to another embodiment, the property tokenization system can be configured such that the ownership tokens can include metadata that includes identification information associated with one or more of the plurality of ownership tokens. The identification information can be configured to distinguish one of the plurality of ownership tokens from another one of the plurality of ownership tokens. Further, the tokenized real estate platform can be configured to receive and distribute rental income generated by the property in the form of cryptocurrency and distribute the rental income in response to an elapse of a predetermined amount of time.

According to another embodiment, the first blockchain network can employ a whitelisting technique that includes a list of selected properties, enterprises, or users that are granted permission to access the first blockchain network. The tokenized real estate platform can also optionally include a SCR mining mechanism for dynamically adjusting a mining speed among the insurance liquidity pool and the investment liquidity pool according to a SCR ratio.

According to still another embodiment, the plurality of ownership tokens has an expense fee associated therewith and the property tokenization system includes a governance unit for generating a plurality of governance tokens, wherein one or more of the governance tokens is issued by the governance unit to replace the expense fee, and the expense fee is removed from the ownership token.

The present invention is also directed to a computer-implemented method for tokening property, comprising providing a first blockchain network having a first blockchain and a first smart contract, providing a tokenized real estate platform for tokenizing property to generate a plurality of ownership tokens in the property, providing a plurality of digital wallets associated with one or more of a plurality of user devices, the tokenized real estate platform, or the first blockchain network, wherein the plurality of digital wallets are configured for receiving and storing one or more of the plurality of ownership tokens. The plurality of ownership tokens can correspond to a real estate asset. The method of the present invention can further restrict transfer of each of the plurality of ownership tokens to a predetermined user or to a user in a predetermined jurisdiction.

The computer-implemented method can further configure the tokenized real estate platform to receive and distribute rental income associated with the property in the form of cryptocurrency to a user after an elapse of a predetermined amount of time in proportion to an amount of ownership tokens owned by the user. The tokenized real estate platform can be configured to receive and distribute rental income generated by the property in the form of cryptocurrency and can include a second blockchain network having a second blockchain and a second smart contract that is configured for storing the plurality of ownership tokens and the rental income generated by the property associated with the plurality of ownership tokens, a cross-chain network for facilitating communication between the first blockchain network and the second blockchain network, a first liquidity pool for aggregating and storing assets from a plurality of users, a property vault for storing one or more of the plurality of ownership tokens via the second smart contract, and a rent vault for storing the rental income. The system can also include an optional token vault for identifying the holders of the plurality of ownership tokens via the second smart contract or for storing additional ones of the plurality of ownership tokens.

The computer-implemented method further contemplates providing an off-chain network that communicates with the second smart contract of the second blockchain network to securely access data and services external to the second blockchain network, and a network of external digital agents for collecting and verifying data from various external data sources. The tokenized real estate platform can receive and distribute rental income generated by the property in the form of cryptocurrency, and can include an operations layer for managing selected financial and insurance operations between one or more of the plurality of user devices and the tokenized real estate platform associated with the first blockchain network. The tokenized real estate platform can also include an insurance liquidity pool for aggregating funds for rental insurance and an investment liquidity pool for aggregating funds for investment. The insurance liquidity pool includes a low-risk reserve pool and a high-risk reserve pool and the rental insurance funds are selectively distributed therebetween based on one or more risk related attributes. The investment liquidity pool can include a low-risk investment pool and a high-risk investment pool and the rental insurance funds are selectively distributed therebetween based on one or more selected investment attributes.

The operations layer can include a pricing model unit for applying one or more actuarial based pricing models to user provided insurance data to determine a cost of insurance based on a plurality of insurance related factors, a loss assessment unit for determining a risk level of each of a plurality of portfolios of insurance products forming part of the insurance liquidity pool, and a risk scoring unit for determining a risk score for each of the plurality of portfolios of insurance products. The risk scoring unit can employ an Aggregate Loss Distribution (ALD) model to estimate an expected loss in each of the plurality of portfolios of insurance products. The ALD model can include a frequency model for estimating a number of claims associated with the plurality of portfolios of insurance products that occur over a selected period of time based on one or more claim related factors, and a severity model for estimating a monetary size of the claim by considering one or more loss related factors.

The computer-implemented method of the present invention also contemplates providing a second blockchain network having a second blockchain and a second smart contract that is configured for storing the plurality of ownership tokens and the rental income generated by the property associated with the plurality of ownership tokens, a cross-chain network for facilitating communication between the first blockchain network and the second blockchain network, and an off-chain network that communicates with the second smart contract of the second blockchain network to securely access data and services external to the second blockchain network. The off-chain network can include a network of external digital agents for collecting and verifying data from various external data sources.

The computer-implemented method can also include a model layer that communicates with the tokenized real estate platform and with the first blockchain network to apply one or more modeling techniques to information stored in the tokenized real estate platform, and a governance unit that communicates with the operations layer to allow the users to perform one or more governance related activities.

The ownership tokens can include metadata that includes identification information associated with one or more of the plurality of ownership tokens. The identification information can distinguish one of the plurality of ownership tokens from another one of the plurality of ownership tokens. Further, the tokenized real estate platform can be configured to receive and distribute rental income generated by the property in the form of cryptocurrency and to distribute the rental income in response to an elapse of a predetermined amount of time.

### BRIEF DESCRIPTION OF THE DRAWINGS

These and other features and advantages of the present invention will be more fully understood by reference to the following detailed description in conjunction with the attached drawings in which like reference numerals refer to like elements throughout the different views. The drawings illustrate principals of the invention and, although not to scale, show relative dimensions.

FIG. 1 is a schematic block diagram of one embodiment of a property tokenization system according to the teachings of the present invention.

FIG. 2 is a flowchart diagram illustrating one embodiment of a method for tokenizing real estate according to the teachings of the present invention.

FIG. 3 is a schematic block diagram illustrating another embodiment of the property tokenization system of the present invention.

FIG. 4 is a schematic block diagram illustrating still another embodiment of the property tokenization system of the present invention.

FIG. 5 is a schematic block diagram illustrating still yet another embodiment of the property tokenization system of the present invention.

FIG. 6 is a schematic block diagram of yet another embodiment of the property tokenization system of the present invention employed as a decentralized finance system that is used to facilitate trading activities.

FIG. 7 is a schematic block diagram of still yet another embodiment of the property tokenization system of the present invention employed as a decentralized real estate insurance platform.

FIG. 8 is a schematic flow chart diagram illustrating the method for tokening property and acquiring property insurance according to the teachings of the present invention.

FIG. 9 is a schematic block diagram of yet another embodiment of the property tokenization system of the present invention showing the details of the operations layer.

FIG. 10 is a schematic flow chart diagram illustrating the steps associated with the liquidation of tokens.

FIG. 11 is a schematic block diagram of another embodiment of the property tokenization system employing a smart contract wallet according to the teachings of the present invention.

### DETAILED DESCRIPTION OF THE INVENTION

While the making and using of various embodiments of the present disclosure are discussed in detail below, it should be appreciated that the present disclosure provides many applicable inventive concepts that are embodied in a wide variety of specific contexts. The specific embodiments discussed herein are merely illustrative of specific ways to make and use the disclosure and do not delimit the scope of the disclosure. Those of ordinary skill in the art will recognize numerous equivalents to the specific apparatus and methods described herein. Such equivalents are considered to be within the scope of this disclosure and are covered by the claims.

As used herein, the term “computing device” or “electronic device” can include a desktop computer, a laptop computer, a tablet computer, a mobile device such as a mobile phone or a smart phone, a smartwatch, a gaming console, an application server, a database server, or some other type of computing device. A computing device can include a physical computing device or can include a virtual machine (VM) executing on another computing device. The computing or electronic device can include a cloud computing system, a distributed computing system, or another type of multi-device system.

As used herein, the term “data network” can include a local area network (LAN), wide area network (WAN), the Internet, or some other network. A data network can include one or more routers, switches, repeaters, hubs, cables, or other data communication components. A data network can include a wired connection or a wireless connection.

As used herein, the term “decentralized” means that at least a portion of information or functionality is not controlled by a single party. Instead the decentralized information or functionality is distributed among several parties whose aggregate behavior affects the information or functionality. One example of a decentralized technology is a distributed ledger.

As used herein, the term “distributed ledger” can include a data storage of transactions replicated across and synchronized by multiple computers, called “nodes,” in communication with each other. The nodes can synchronize the data of the distributed ledger, including which transactions are added to the ledger and in what order, using a consensus mechanism. The transactions can be cryptographically secured such that once a transaction is added to the distributed ledger, the transaction cannot be later modified. Basic encryption or cryptography principles. such as a public key infrastructure, digital signatures, and other cryptographic technologies, underlie the application of distributed ledger technology. When a user adds a distributed ledger transaction, the user can digitally sign the transaction such that other parties can verify that the transaction originated from that user. One example implementation of a distributed ledger includes a blockchain.

As used herein, the term “blockchain” can include a list of blocks that are cryptographically linked together. Each block can include one or more blockchain transactions. Each block can include a cryptographic hash of the previous block in the blockchain. Each block can include a timestamp, which can include the timestamp of when the block was generated or when the block was added to the blockchain. The blockchain can be maintained as replicated and synchronized copies across a blockchain network of nodes. The nodes can generate blocks and can determine which transactions are included in which blocks and in what order, and the nodes can synchronize their blockchain copies via a consensus mechanism.

As used herein, a “token” or “ownership token” or “security token” can include a data asset represented by data on a blockchain. The token can be transferable between blockchain users via a transaction from a first user to a second user. As used herein, a “tokenized” asset can refer to an asset whose ownership interest is represented by one or more tokens. Thus, a user who owns a token can own at least a portion of the corresponding asset. A token representing a tokenized asset can directly represent ownership of the asset or indirectly represent ownership of the asset. A token directly representing ownership can include the token itself representing ownership of the asset. A token indirectly representing ownership of the asset can include the token representing ownership of some other thing, which in turn can represent ownership of the asset. As an example of a token indirectly representing ownership of an asset, a token can represent ownership of at least part of a business entity such as a corporation, and the corporation can own a piece of real estate property. The token thus represents indirectly ownership of the piece of real estate property even though it is through direct ownership of the business entity. As used herein, the term “tokenization” is intended to mean or refer to the process of digitizing property or an asset and creating a token.

As used herein, the term “transaction” can include a blockchain transaction. A blockchain transaction can include a source address, a destination address, an amount of cryptocurrency or a token, a timestamp indicating when the transaction was generated or other data.

As used herein, a “digital wallet” or a “cryptocurrency wallet” can include data that can allow a user of a blockchain network to send or receive cryptocurrency or tokens via the blockchain network. The wallet can include one or more public keys, private keys, or other cryptographic components used to generate transactions. The wallet can include a corresponding wallet address that can uniquely identify the cryptocurrency wallet. The digital wallets can include cold wallets such as hardware wallets and paper wallets, and hot wallets such as software wallets including web wallets, mobile wallets, desktop wallets, and smart contract wallets. The hardware wallet corresponds to a physical device functioning as a wallet for storing data offline, such as private keys. The desktop wallet can be a wallet that is installed on a desktop computer, a mobile wallet can be a wallet that is installed on a smartphone, and a web wallet can be a wallet that is accessed through a web browser. The smart contract wallets use smart contracts to manage a digital asset, such as cryptocurrency.

As used herein, the terms a first user “sending” a second user cryptocurrency or a token can include the first user generating a transactions where the destination address is the cryptocurrency wallet address of the second user. Hence, using a cryptocurrency wallet cannot mean data is sent from, received at, or held in a cryptocurrency wallet, but, instead, transactions of the blockchain network indicate that the owner of the wallet has ownership of certain cryptocurrency or tokens.

As used herein, the terms “determine” or “determining” can include a variety of actions. For example, “determining” can include calculating, computing, processing, deriving, looking up (e.g., looking up in a table, a database or another data structure), ascertaining, or other actions. Also, “determining” can include receiving (e.g., receiving information or data), accessing (e.g., accessing data in a memory, data storage, distributed ledger, or over a network), or other actions. Also, “determining” can include resolving, selecting, choosing, establishing, or other similar actions.

As used herein, the terms “provide” or “providing” can include a variety of actions. For example, “providing” can include generating data, storing data in a location for later retrieval, transmitting data directly to a recipient, transmitting or storing a reference to data, or other actions. “Providing” can also include encoding, decoding, encrypting, decrypting, validating, verifying, or other actions.

As used herein, the term “access,” “accessing”, and other similar terms can include a variety of actions. For example, accessing data can include obtaining the data, examining the data, or retrieving the data. Providing access or providing data access can include providing confidentiality, integrity, or availability regarding the data.

As used herein, the term “message” can include one or more formats for communicating (e.g., transmitting or receiving) information or data. A message can include a machine-readable collection of information such as an Extensible Markup Language (XML) document, fixed-field message, comma-separated message, or another format. A message can, in some implementations, include a signal utilized to transmit one or more representations of information or data.

As used herein, the term “user interface” (also referred to as an interactive user interface, a graphical user interface or a UI), can refer to a computer-provided interface including data fields or other controls for receiving input signals or providing electronic information or for providing information to a user in response to received input signals. A user interface can be implemented, in whole or in part, using technologies such as hyper-text mark-up language (HTML), a programming language, web services, or rich site summary (RSS). In some implementations, a user interface can be included in a stand-alone client software application configured to communicate in accordance with one or more of the aspects described.

As used herein, the term “modify” or “modifying” can include several actions. For example, modifying data can include adding additional data or changing the already-existing data. As used herein, the term “obtain” or “obtaining” can also include several types of action. For example, obtaining data can include receiving data, generating data, designating data as a logical object, or other actions. For example, obtaining a verifiable credential can include designating a credential and digital signatures of the credential.

As used herein, the term “enterprise” is intended to include all or a portion of a company, a structure or a collection of structures, facility, business, company, firm, venture, joint venture, partnership, operation, organization, concern, establishment, consortium, cooperative, franchise, or group or any size. Further, the term is intended to include an individual or group of individuals, or a device or equipment of any type.

As used herein, the term “property” is intended to include assets, such as tangible and intangible assets, including real property such as land, real estate, buildings, and the like, and personal property, which includes money, cash, cash equivalents, financial instruments and the like. The tokens can be used to represent shares in a real estate property. When the token is made available for purchase in a market, investors can be given partial ownership of the property equivalent to the number of tokens owned by the investor. The investors also have the option to sell as many tokens as they require or choose.

The term “application” or “software application” or “program” as used herein is intended to include or designate any type of procedural software application and associated software code which can be called or can call other such procedural calls or that can communicate with a user interface or access a data store. The software application can also include called functions, procedures, and/or methods.

Reference throughout this specification to “one embodiment,” “an embodiment,” “another embodiment,” or similar language means that a particular feature, structure, or characteristic described in connection with the embodiment is included in at least one embodiment. Thus, appearances of the phrases “in one embodiment,” “in an embodiment,” “in some embodiments,” and similar language throughout this specification can, but do not necessarily, all refer to the same embodiment, but mean “one or more but not necessarily all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. As used herein, the term “a,” “an,” or “the” means “one or more” unless otherwise specified. The term “or” means “and/or” unless otherwise specified.

Multiple elements of the same or a similar type can be referred to as “Elements 12(1)-(n)” where n can include a number. Referring to one of the elements as “Element 12” refers to any single element of the Elements 12(1)-(n). Additionally, referring to different elements “First Elements 12(1)-(n)” and “Second Elements 14(1)-(n)” does not necessarily mean that there must be the same number of First Elements as Second Elements and is equivalent to “First Elements 12(1)-(n)” and “Second Elements (1)-(m)” where m is a number that can be the same or can be a different number than n.

In a blockchain, as is known, the original data or enriched data can be stored in a series of batches or blocks that include, among other things, a time stamp, a hash value of the data stored in the block, a copy of the hash value from the previous block, as well as other types of information, including for example the origins of the data. The blockchain is shared with a plurality of nodes in a blockchain network in a decentralized manner with no intermediaries. Since many copies of the blockchain exist across the blockchain network, the veracity of the data in the blocks can be easily tracked and verified. Each instance of new data from the data sources can be stored in a block on the blockchain. The blockchain thus functions as a decentralized or distributed ledger having data associated with each block that can be subsequently reviewed and/or processed. The data in the blockchain can be tracked, traced, and presented chronologically in a cryptographically verified ledger format of the blockchain to each participant of the blockchain. As such, the blockchain can provide an audit trail corresponding to all data in the blocks, and thus can determine who interacted with the data and when, as well as the sources of the data and any actions taken in response to the data. According to one embodiment, each node of the blockchain network can include one or more computer servers which provides processing capability and memory storage. Any changes made by any of the nodes to a corresponding block in the blockchain are automatically reflected in every other ledger in the blockchain. As such, with the distributed ledger format in the blockchain, provenance can be provided with the dissemination of identical copies of the ledger, which has cryptographic proof of its validity, to each of the nodes in the network. Consequently, all the various types of data can be stored in the blockchain, and the blockchain can be used to verify, prove and create an immutable record of the data.

As used herein, the term “smart contract” is intended to mean executable computer code, logic or protocols that is stored in the blockchain as part of a blockchain network and which enables the property tokenization system to generate data for storage in the blockchain according to a predefined set of rules or when a set of predefined conditions occur. As such, the smart contract can process incoming data that satisfies the predefined rules and generates new information or facts that are added to a ledger of the blockchain. The smart contract thus enables the enterprises to transact business with each other according to a set of common defined terms, data, rules, concept definitions, and processes. Taken together, the smart contracts lay out the business model that govern all of the interactions between transacting clusters, enterprises, or parties. The smart contract thus defines the rules between different enterprises, in executable code. Applications invoke the smart contract to generate transactions that are recorded on the ledger. Specifically, the smart contract implements the governance rules for any type of business object, so that they can be automatically enforced when the smart contract is executed. For example, the smart contract can ensure that a new car delivery is made within a specified timeframe, or that funds are released according to prearranged terms, improving the flow of goods or capital respectively. Most importantly, the execution of a smart contract is much more efficient than a manual human business process. The smart contracts can be grouped together to form a chaincode, which can be used by administrators to group together related smart contracts for deployment. In general, the smart contract defines the transaction logic that controls the lifecycle of a business object contained in a world state. The smart contract can then be packaged into a chaincode which is deployed to the blockchain. As such, the smart contract can be considered to govern transactions, whereas chaincode governs how the smart contracts are packaged for subsequent deployment. One or more of the smart contracts can be defined within a chaincode. When the chaincode is deployed, all smart contracts within it are made available to applications.

At a basic level, the blockchain immutably records transactions which update states in a ledger. The smart contract can programmatically access two distinct pieces of the blockchain ledger, namely, a blockchain, which immutably records the history of all transactions, and a world state that holds a cache of the current value of these states. The blockchain is an immutable ledger of all transactions that have occurred, where every transaction is reflected as an object recorded to the blockchain in a discrete block. Each block of the chain contains an object key. Multiple transactions with the same object key can occur. The world state is in essence a database that sits on the blockchain and holds current values for a given object key. The world state changes over time as new transactions reference the same object key. As a result, the blockchain determines the world state, and the ledger is comprised of both the blockchain and the world state. The smart contracts primarily put, get and delete states in the world state, and can also query the immutable blockchain record of transactions. The “get” typically represents a query to retrieve information about the current state of a business object. The “put” typically creates a new business object or modifies an existing one in the ledger world state, and the “delete” typically represents the removal of a business object from the current state of the ledger, but not the history of the ledger.

Further, when the smart contract executes, the contract runs on a peer node that forms part of the blockchain network. The smart contract takes a set of input parameters called the transaction proposal and uses them in combination with program logic to read from and write to the ledger. Changes to the world state are captured as a transaction proposal response, which contains a read-write set with both the states that have been read, and the new states that are to be written if the transaction is valid. The world state is typically not updated when the smart contract is executed.

The tokenization of property by the property tokenization system of the present invention involves converting the value of the property into digital tokens using particular blockchain real estate tokenization platforms.

As an overview, a piece of real estate can be tokenized into one or more ownership tokens. The tokens can be made available for sale on a tokenized real estate platform by a person, such as a user, investor or stakeholder. The user or investor of the tokenized real estate platform can acquire one or more of the tokens. Ownership of the token gives the investor an interest in the underlying real estate property. The investor can acquire further tokens corresponding to the real estate property from the platform, a cryptocurrency exchange, or from other users. The real estate property can generate income (e.g., via rental payments in exchange for occupancy of the tokenized piece of real estate). The income can be distributed to the holder(s) of the tokens.

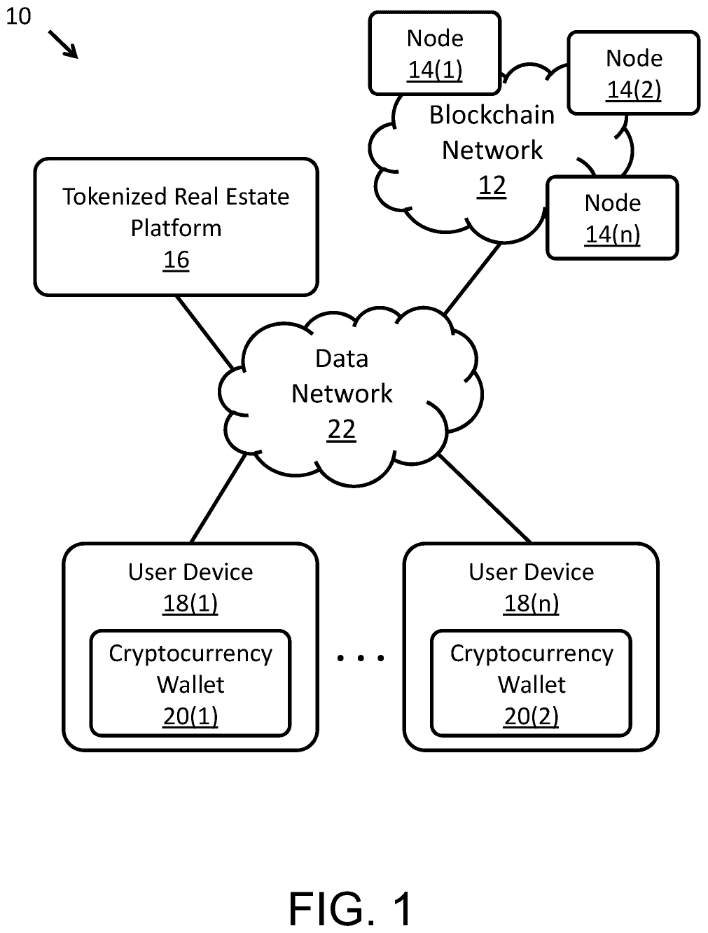

One embodiment of a property tokenization system suitable for converting property into one or more tokens is shown for example in FIG. 1. The illustrated property tokenization system can include a blockchain network 12 having one or more nodes 14(1)-(n). The blockchain network 12 can also include a blockchain and an associated smart contract. The blockchain network 12 can communicate with a tokenized real estate platform 16 via a data network 22. The illustrated property tokenization system 10 can also include one or more user devices 18(1)-(n). The system can include one or more digital wallets, and the digital wallets can be associated with any selected portion of the system. According to one embodiment, the user device 18 can include a digital wallet, such as a cryptocurrency wallet 20, suitable for holding or storing any type of digital asset, such as cryptocurrency or one or more tokens. The digital wallets provide a secure and convenient way to manage digital assets and facilitate transactions on the blockchain network 12. The user device 18 can interact with the blockchain network 12 or the tokenized real estate platform 16 in order to execute functionality related to selected tokenized property, such as tokenized real estate. The data network 22 can include one or more computing or communications devices to enable data communication between various elements of the property tokenization system 10. The blockchain network 12 can include one or more smart contracts that execute on the nodes 14(1)-(n). The blockchain network 12 can be configured to be permissioned or permissionless. In one embodiment, the blockchain network 12 can include the Ethereum blockchain network or a portion of the Ethereum blockchain network.

In some embodiments, the tokenized real estate platform 16 can include one or more computing or electronic devices as well as one or more data storage devices, such as a file system, a database, or other types of storage. The tokenized real estate platform 16 can include a platform that executes functionality related to the tokenization, management, control, processing and/or governance of tokenized property, such as tokenized real estate. The tokenized real estate platform 16 can include one or more user or investor accounts that correspond to users of the platform 16 or can communicate with one or more user or investor accounts or intermediaries. The user can optionally interact with the tokenized real estate platform 16 either directly or indirectly via the user device 18 in order to perform or initiate selected types of functionalities on the platform 16. The tokenized real estate platform 16 can also optionally assist in controlling or managing the execution or minting of the tokens, which can occur in the blockchain network 12 via an associated smart contract, or with the control, management, storing, and/or dissemination of the tokens. The liquidity pool can also optionally include one or more liquidity pools for storing assets and for managing investments.

In one or more embodiments, the user device 18 can include a computing or electronic device. The user of the user device 18(1) can use the user device 18(1) to interact with the tokenized real estate platform 16, the blockchain network 12, or another user device 18(2). The user device 18 can include the cryptocurrency wallet 20. In some embodiments, the cryptocurrency wallet 20 can include data stored on the user device 18 itself or data accessible to the user device 18 over the data network 22 (e.g., data stored on a cloud computing device).

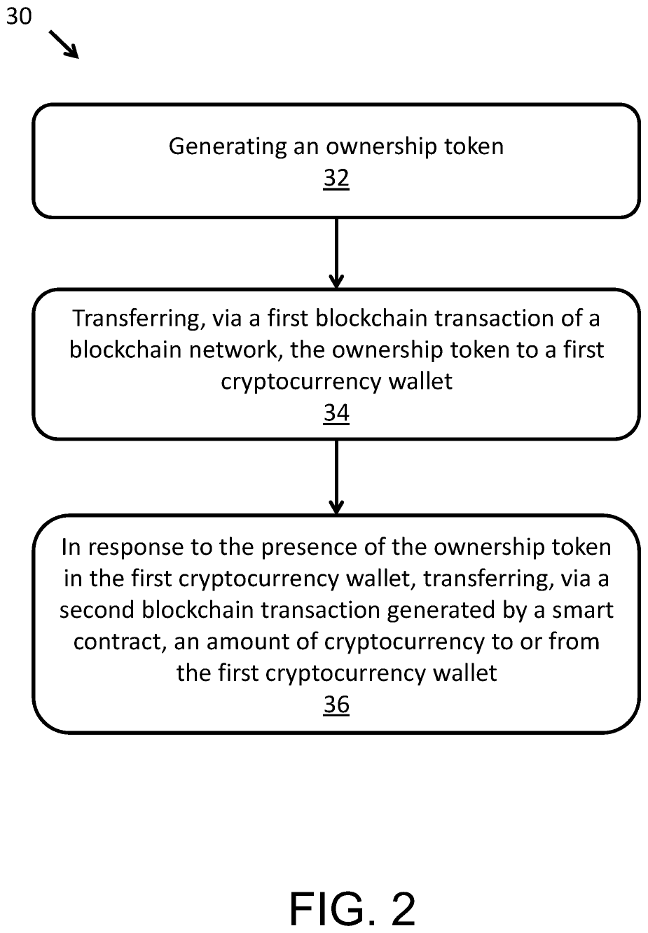

FIG. 2 is a schematic flow chart diagram illustrating a method for tokenizing property, such as real estate. The illustrated method 30 can include generating an ownership token, step 32, such as by the tokenized real estate platform 16. The method 30 can include transferring, via a first blockchain transaction of the blockchain network 12, the ownership token to a first cryptocurrency wallet 20(1) address, step 34. The method 30 can also include, in response to the presence of the ownership token in the first cryptocurrency wallet 20(1), transferring, via a second blockchain transaction generated by a smart contract, an amount of cryptocurrency to or from the first cryptocurrency wallet 20(1), step 36. In some embodiments, one or more elements of the property tokenization system 10 can carry out the steps of the method 30.

Further details regarding the method 30 are disclosed herein. In one embodiment, generating the ownership token (step 32) can include generating multiple ownership tokens. The multiple ownership tokens can correspond to any selected type of property, such as real estate. In one embodiment, generating the ownership token can include minting the ownership token on the blockchain portion of the blockchain network 12. The tokenized real estate platform 16 can optionally generate a blockchain transaction that includes data about minting the ownership tokens associated with the real estate and can send or convey the blockchain transaction to the blockchain network 12 for inclusion in the blockchain. In some embodiments, the tokenized real estate platform 16 can send data to a node 14, a smart contract, or other component of the blockchain network 12, and the node 14, smart contract, or other component can generate the blockchain transaction. In other embodiments, an oracle of the blockchain network 12 can detect the presence of some data and, in response, cause the blockchain network 12 to generate the blockchain transaction. The oracle refers to a third-party service or software that provides external data to a smart contract on the blockchain network. The oracle can optionally function as a bridge between the smart contract and external data sources, such as the tokenized real estate platform 16 or the user devices 18, providing information to the smart contract so that the smart contract can execute instructions accordingly. As such, the oracle enables the smart contracts to interact with the real world, making blockchain-based applications more versatile and useful. According to other embodiments, the system can employ a chainlink to provide token price information and to assist with managing and controlling liquidation of the tokens.

In one embodiment, generating the ownership token (step 32) can include establishing an enterprise, such as any selected type of company or partnership, with the proper governmental entity. The legal framework of the government entity can allow the company to segregate membership interests, assets, or operations into one or more independent series. A series of the company can be treated as a separate entity called a “company series,” referred to herein as a “series.” In some embodiment, the series can purchase or own a piece of real estate. In one embodiment, the tokenized real estate platform 16 (or the entity that operates the platform 16) can tokenize the series and, thus, tokenize the real estate owned by the series. An ownership token of the series can correspond to an ownership interest in the series. In one embodiment, each ownership token that corresponds to a series can correspond to an equal amount of ownership interest. In such a case, each ownership token corresponding to that series can be fungible. In other embodiments, ownership tokens can correspond to different amounts of ownership interest. The ownership interest amount can be included in the metadata of the token, data on the blockchain, or in some other location.

In one embodiment, the ownership token can include metadata. The metadata can include data describing or associated with the token, the tokenized series, the tokenized real estate property, or other selected information. The metadata can optionally include identification information, such as an identification number. The identification number can distinguish the ownership token from all other ownership tokens that correspond to the same series, or optionally the tokens associated with the same series can have the same identification information. The identification number can distinguish the ownership token from all other ownership tokens governed or otherwise coordinated by the tokenized real estate platform 16. In some embodiments, the metadata can include data identifying the tokenized piece of property or the tokenized series.

In certain embodiments, the ownership token can include an Ethereum Request for Comments 20 (ERC-20) compliant token. In some embodiments, the ownership token can include data restricting transfer of the ownership token to a user in a predetermined jurisdiction. Restricting transfer of the ownership token to a user in a predetermined jurisdiction can include preventing a user located in one or more predetermined jurisdictions from holding the token or only allowing users from one or more predetermined jurisdictions to hold the token. For example, an ownership token can include data preventing the token from being held by a user located in the United States. In another example, an ownership token can include data that only allows users located in France to hold the token.

In some embodiment, the ownership token can optionally include a non-fungible token (NFT). The tokenized real estate platform 16 can thus optionally send data to an optional NFT engine of the blockchain network 12, and the NFT engine can mint an NFT based on the data and a NFT minting smart contract.

In one embodiment, in response to the ownership tokens created or minted, the blockchain network 12 can place the ownership tokens in the cryptocurrency wallet 20. The cryptocurrency wallet 20 can be owned, operated, or controlled by the tokenized real estate platform 16 or the entity that owns, operates, or controls the platform 16, or by the user of the system.

In one embodiment, transferring, via a first blockchain transaction of a blockchain network 12, an ownership token to a first cryptocurrency wallet 20(1) address (step 34) can include transferring the ownership token from a cryptocurrency wallet associated with the tokenized real estate platform 16 to the cryptocurrency wallet 20(1) of a user of the tokenized real estate platform 16. In one embodiment, the user of the platform 16 can include the user of the user device 18(1). The user can use the user device 18(1) or some other computing device to interact with a user interface (UI). The UI can include a UI for a web page, a mobile application, a software application, or some other UI. The UI can be in data communication with the tokenized real estate platform 16 over the data network 22. The UI can include a listing of one or more tokenized properties, whether ownership tokens are available for purchase for a certain tokenized property, a price of an ownership token, or other information regarding tokenized real estate.

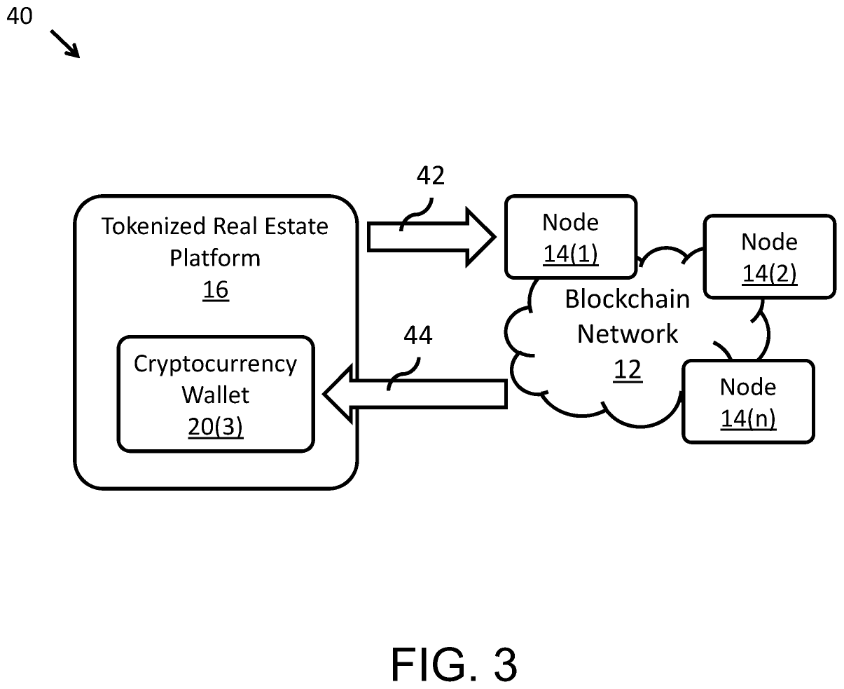

In one embodiment, the user can purchase an ownership token in exchange for fiat currency. For example, the user can input a payment card number into the UI to purchase one or more of the ownership tokens. In another embodiment, the user can purchase an ownership token in exchange for an amount of cryptocurrency. For example, the user can generate a blockchain transaction that transfers cryptocurrency from the user's cryptocurrency wallet 20(1) to the cryptocurrency wallet 20(3) of the tokenized real estate platform 106 (see FIG. 3).

In some embodiments, the tokenized real estate platform 16 can determine whether the user of the user device 18 that controls the cryptocurrency wallet 20 is authorized to own the ownership token. The tokenized real estate platform 16 can implement know-your-customer (KYC) or anti-money laundering (AML) procedures prior to transferring an ownership token to a user's cryptocurrency wallet 20. In one embodiment, the tokenized real estate platform 16 can make the determination during a signup process when the user establishes an account with the tokenized real estate platform 16. In another embodiment, the tokenized real estate platform 16 can make the determination prior to the user purchasing an ownership token.

FIG. 3 depicts another embodiment of a property tokenization system 40 suitable for generating the ownership tokens (step 32 of the method 30). The property tokenization system 40 can include the tokenized real estate platform 16 and the blockchain network 12. The tokenized real estate platform 16 can send data 42 to a node 14(1) of the blockchain network 12. The data 42 can data associated with a blockchain transaction that instructs the blockchain network 12 to create or mint one or more ownership tokens. Alternatively, the tokenized real estate platform 16 can include structure, such as a minting authority, to generate the ownership tokens, or the tokenized real estate platform 16 can communicate with a separate minting authority that generates the ownership tokens, or can be configured to control, store or disseminate the tokens. In this embodiment, the data 42 includes information regarding the ownership tokens. The node 14(1) can receive the data and record the minting of the one or more ownership tokens on the blockchain of the blockchain network 12 via a consensus mechanism of the blockchain network 12. Minting the one or more ownership tokens can include placing the one or more ownership tokens 44 in the cryptocurrency wallet 20(3) of the tokenized real estate platform 16. The minting of the ownership tokens can be managed or created by the smart contract associated with the blockchain. The smart contract can be configured to generate one or more tokens according to predefined instructions. According to one embodiment, the predefined instructions can include converting a plurality of tokens of a first type into one or more tokens of a second type. The generation of the second type of tokens can be based on the instructions associated with the smart contract, as well as based on price information and/or token specific information (e.g., number of first tokens) associated with the first type of tokens. The second type of tokens generated by the blockchain network 12 can be stored in the tokenized real estate platform 16, and preferably in a liquidity pool associated with the tokenized real estate platform 16. The liquidity pool can then convey the second type of token to a user account, such as a digital wallet, or can optionally create ort mint a third type of token that can be conveyed to the user account. The user can use the received tokens as collateral for purchasing other tokens or for purchasing property or an interest in property.

In some embodiments, transferring an ownership token (step 34) can include or involve a cryptocurrency exchange transferring the ownership token. A cryptocurrency exchange can include an entity that allows other entities to trade assets for cryptocurrency. One or more ownership tokens can be listed on a cryptocurrency exchange, and the user can use the cryptocurrency exchange to purchase one or more ownership tokens. In one embodiment, the cryptocurrency exchange can determine, based on data associated with the ownership token (e.g., the metadata of the token) whether the user is authorized to hold the ownership token. In one embodiment, the cryptocurrency exchange can include a decentralized exchange (DEX). The DEX can be a type of cryptocurrency exchange that operates on the decentralized blockchain network 12, allowing the users to trade cryptocurrencies without the need for a centralized authority or intermediary. Instead of relying on a central authority to manage trades and hold funds, the decentralized exchange uses smart contracts and decentralized technology to automate trades and facilitate transactions directly between the users. The decentralized exchange can offer greater privacy, security, and control over funds, as users maintain control over their private keys and do not need to deposit their assets into a central exchange wallet. Instead, the trades are executed through the smart contracts on the blockchain network 12, which act as self-executing computer programs that automatically execute trades when certain conditions are met.

In some embodiments, in response to owning an ownership token and holding the ownership token in the cryptocurrency wallet 20, the user of the cryptocurrency wallet 20 can own an ownership interest in the series associated with the ownership token and thus can have an interest in the real estate property owned by the series. The user can have access to certain documents associated with the real estate asset. Such documents can include a certificate of formation of the company or the series, the operating agreement of the company, the deed to the real estate property, building inspection reports, insurance documents (title, homeowners, renters, etc.), maintenance history documents, documents logging repairs or renovations, tax documents, or other documents associated with the real estate property. The documents can be available to the user via a distributed file system. The user can receive access to the documents in response to holding an ownership token in the user's cryptocurrency wallet 20. In one embodiment, the distributed file system can include the InterPlanetary File System.

In some embodiments, in response to the presence of an ownership token 44 in the first cryptocurrency wallet 20(1), the method 30 can include transferring, via a second blockchain transaction generated by a smart contract, an amount of cryptocurrency to or from the first cryptocurrency wallet 20(1), step 36. During step 36, the owner of the ownership token can receive profits or rent from the tokenized real estate property. In one embodiment, the series can use a property management entity to, among other things, collect rent from the one or more tenants of the tokenized real estate asset. Alternatively, the tokenized real estate platform 16 can be configured and employed to perform these functions. The tenants can pay rent in fiat currency or cryptocurrency. The property management entity can exchange the collected rent for a certain cryptocurrency. The property management entity can then transfer the cryptocurrency to the cryptocurrency wallet 20(3). The wallet can be operated by the tokenized real estate platform 16, by the suer device 18 or can be a separate wallet. The tokenized real estate platform 16 can then be configured to distribute the cryptocurrency from the wallet 20(3) of the platform to one or more wallets 20 of the users. In some embodiments, the property management entity can use a cryptocurrency exchange to exchange the collected fiat currency or the cryptocurrency to the desired cryptocurrency. In some embodiments, the cryptocurrency can include a stablecoin. The stablecoin can include the DAI stablecoin. In one embodiment, a stablecoin can include a cryptocurrency that can be configured to be pegged to some other asset such as another cryptocurrency, a fiat currency, or a commodity.

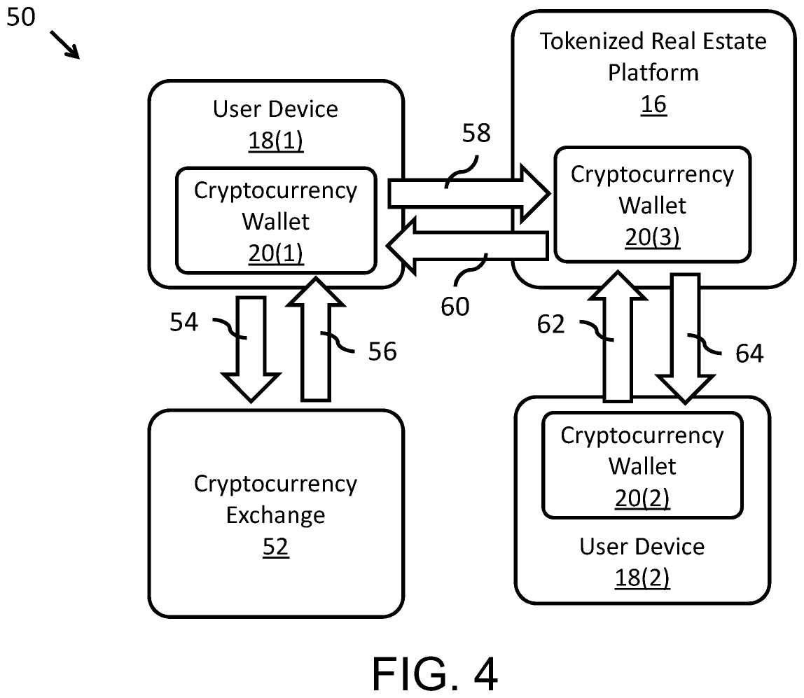

FIG. 4 depicts another embodiment of a property tokenization system 50 for carrying out portions of the step 34 of FIG. 2. The property tokenization system 50 can include the tokenized real estate platform 16 and the user devices 18(1)-(2). The property tokenization system 50 can also include a cryptocurrency exchange 52. The cryptocurrency exchange 52 can be separate or can form part of the blockchain network 12. In some embodiments, a first user can purchase an ownership token from the tokenized real estate platform 16. The first user can exchange fiat currency for a cryptocurrency that the tokenized real estate platform 16 accepts as payment. Thus, the first user can use the user device 18(1) to send fiat currency 54 to the cryptocurrency exchange 52 (e.g., by inputting payment card information into a UI of the cryptocurrency exchange 52). In response, the cryptocurrency exchange 52 can send a corresponding amount of cryptocurrency 56 to the user's cryptocurrency wallet 20(1). The transfer of cryptocurrency can be recorded on the blockchain of the blockchain network 12. Although shown as part of the user device 18, the cryptocurrency wallet can be separate from the user device.

Continuing the example of FIG. 4, the first user can send an amount of cryptocurrency 58 to the cryptocurrency wallet 20(3) of the tokenized real estate platform 16. In response, the tokenized real estate platform 16 can send an ownership token 60 to the first user's cryptocurrency wallet 20(1). Also depicted in FIG. 4, a second user of a second user device 18(2) can already have sufficient cryptocurrency to purchase an ownership token from the tokenized real estate platform 16. Thus, the second user does not need to use the cryptocurrency exchange 52. The second user can send an amount of cryptocurrency 62 to the cryptocurrency wallet 20(3) of the tokenized real estate platform 16, and in response, the platform 16 can send an ownership token 64 to the cryptocurrency wallet 20(2) of the second user. One or more of the exchanges of cryptocurrency and ownership tokens can be affected through and recorded in the transactions of the blockchain.

In one embodiment, step 36 of FIG. 2 can include the tokenized real estate platform 16 transferring some of the cryptocurrency derived from the rental payments of the tokenized real estate property to the first cryptocurrency wallet 20(1). The tokenized real estate platform 16 can perform the cryptocurrency transfer via a smart contract of the blockchain network 12. The smart contract can generate one or more blockchain transactions that transfer the cryptocurrency. The transactions can include, as a destination address, the cryptocurrency wallet addresses 20 of the owners of the ownership tokens that correspond to the real estate asset from which the rental payments was collected. The process of the tokenized real estate platform 16 distributing the cryptocurrency derived from rental payments of a real estate property to the owners of ownership tokens corresponding to that real estate property can be referred to as distributing rental income or profits.

The tokenized real estate platform 16 can distribute the rental income stored and accumulated therein according to predefined instructions, such as for example evenly according to the number of ownership tokens owned by the user. For example, if the tokenized real estate platform 16 has tokenized a piece of real estate into 100 ownership tokens, then each token owner can receive 1/100th of the cryptocurrency for each ownership token the owner holds in the user's cryptocurrency wallet 20. Thus, if a user owns seven ownership tokens corresponding to the real estate property, then that user can receive 7/100ths of the cryptocurrency. In some embodiments, the tokenized real estate platform 16 can distribute the rental income on some other basis or predefined instructions. For example, an ownership token's metadata can include data that indicates how much of a share of the rental profits the token owner should receive.

In one embodiment, the tokenized real estate platform 16 can distribute the rental income in response to a predetermined amount of time elapsing since the tokenized real estate platform 16 distributed rental income for the specific real estate property. The predetermined amount of time can include, by simple way of example, a month, a week, a day, an hour, a minute, a predetermined number of seconds, or some other amount or unit of time. In another embodiment, the tokenized real estate platform 16 can distribute rental profits in response to the addition of a block to the blockchain of the blockchain network 12. The tokenized real estate platform 16 can be configured to divide an owner's portion of the rental income into equal amounts based on the payment frequency. For example, if the payment frequency is daily, then the tokenized real estate platform 16 can divide an owner's portion of the rental profits into 28, 30, or 31 equal amounts (depending on the particular month and the days associated therewith) and distribute one of those amounts each day.

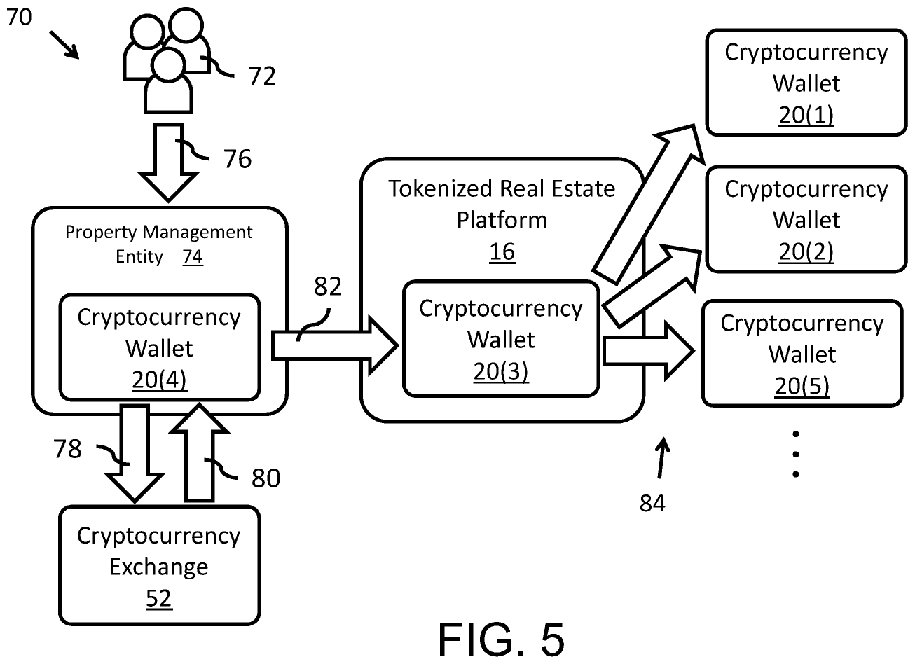

FIG. 5 depicts yet another embodiment of a property tokenization system 70 suitable for carrying out portions of the step 36 of FIG. 2. The property tokenization system 70 can include the tokenized real estate platform 16 and one or more cryptocurrency wallets 20(1), 20(2), 20(5)-(n). The wallets can be associated with one or more users or user devices 18 or can be separate therefrom. The property tokenization system 70 can include one or more tenants 72 of a tokenized piece of real estate and an optional property management entity platform 74 that manages the tokenized piece of real estate, which can include one or more computing devices. The property management system 70 can be separate from the tokenized real estate platform 16 or can form a portion of the platform 16. In one embodiment, the one or more tenants 72 can make rental payments 76 to the property management entity 74 in exchange for occupying or renting the tokenized piece of real estate. The rental payments 76 can include payments made in fiat currency or cryptocurrency. The property management entity platform 74 can send a portion of the rental payment amount 78 to the cryptocurrency exchange 52 in order to exchange the payments, if made in fiat currency, for a corresponding amount of cryptocurrency 80, for subsequent use by the property management entity platform 16. The cryptocurrency exchange 52 can send a corresponding amount of cryptocurrency 80 to a cryptocurrency wallet 20(4) operated by the property management entity 74. The property management entity platform 74 can then send the rental payments in the form of rental income 82 (in cryptocurrency form) to the tokenized real estate platform 16. According to one embodiment, the rental income 82 can be stored in a cryptocurrency wallet 20(3) of the tokenized real estate platform 16. The tokenized real estate platform 16 can then distribute the rental income 84 to one or more cryptocurrency wallets 20(1), 20(2), 20(5)-(n) whose owners hold one or more ownership tokens corresponding to the piece of real estate occupied by the tenants 72. The exchanges of cryptocurrency can be recorded on the blockchain of the blockchain network 12.

In one embodiment, a user that has received rental income in the form of cryptocurrency can exchange the cryptocurrency for fiat currency via the cryptocurrency exchange 52. In another embodiment, the user can use the cryptocurrency to reinvest the rental income by using the tokenized real estate platform 16 to purchase further ownership tokens. The ownership tokens can include ownership tokens corresponding to the real estate asset from which the rental income was received (if such ownership tokens are still available for purchase) or can include ownership tokens corresponding to a different piece of tokenized real estate.

In some embodiments, a first user can transfer an ownership token to a second user. The first user can generate a blockchain transaction with the source address as the cryptocurrency wallet 20(1) address of the first user and the destination address as the cryptocurrency wallet address of the second user. The first user can transfer the ownership token in exchange for cryptocurrency, an ownership token that corresponds to a different tokenized real estate property, something else of value, or as a gift. In some embodiments, the users can utilize the tokenized real estate platform 16 to complete the transfer (e.g., so the platform 16 can perform any Know Your Customer (KYC) or AML determination or to act on other restrictions on ownership of an ownership token). The tokenization of the property can provide for a number of advantages and benefits. For example, the tokenization of the property provides for increased liquidity of the underlying property asset, lower barriers to ownership of the property asset, employ smart contracts to standardize transactions, and increase transparency of the associated transactions.

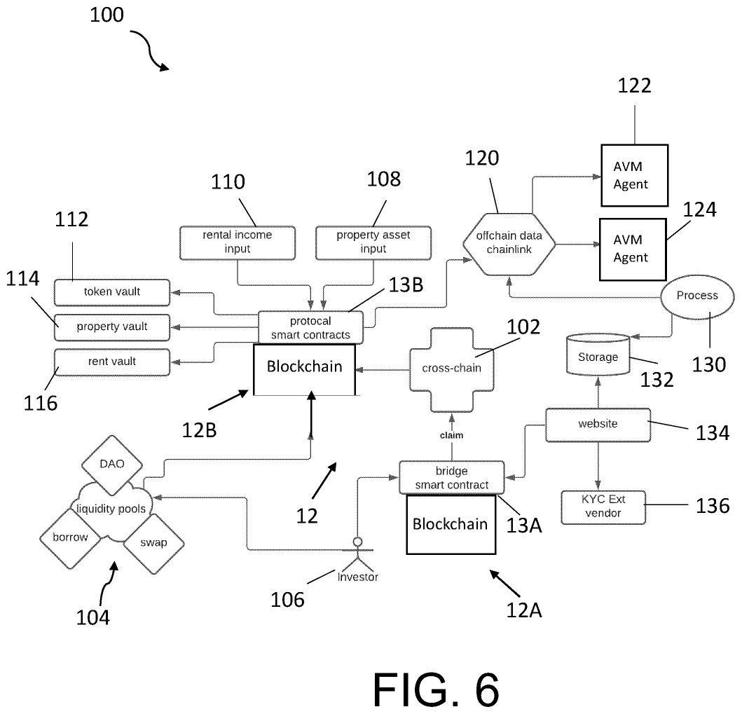

FIG. 6 is still another example of a property tokenization system for tokenizing property, such as real estate. The illustrated property tokenization system 100 of the present invention allows the owner to select the type of property to tokenize. For example, the users of the system have the option of tokenizing real estate, an equity interest within a legal entity that owns the real estate, a mortgage on the real estate property, a right to share in the property's revenues (e.g., rent), and the like. The token requirements can differ based on the type of interest or property being tokenized. As a result, the tokenization can include coded rules for any regulations that may apply. The property tokenization system 100 can employ smart contracts, which are based in the blockchain of the blockchain network 12, which can be configured to automatically establish and enforce agreements between users without the participation of a third party. The ownership tokens created by the property tokenization system of the present invention can be configured to comply with the rules and regulations, for example, of the Securities and Exchange Commission (SEC) in the circumstance where the tokens are deemed to be securities under state and federal law. While the systems and methods disclosed herein have focused on tokenized real estate, the systems and methods can also be applied to other types of property as well. For example, the systems and methods can be applied to an enterprise (such as a for-profit corporation), a vehicle, a timeshare, a commodity, or some other asset where ownership can be tokenized and profits from the asset distributed to the owners of the corresponding ownership tokens.

The illustrated property tokenization system 100 includes a first blockchain network 12A and a second blockchain network 12B that communicate with each other via the cross-chain network 102. The cross-chain network 102 is a network that enables the blockchain networks 12 to communicate with each other by using a selected communication protocol. The cross-chain network 102 enables the blockchain networks 12A, 12B to communicate with each other to exchange data, assets, or tokens without the need for intermediaries, which can be useful in various applications, such as in decentralized exchanges, where users can trade cryptocurrencies from different blockchain networks. The cross-chain network 102 interoperability can be achieved through various methods, such as by using atomic swaps, sidechains, and decentralized bridges. Atomic swaps are peer-to-peer trades between users on different blockchains, while sidechains allow for the creation of parallel chains that can interact with the main chain. Decentralized bridges use smart contracts to facilitate communication and asset transfers between different blockchains. Overall, the cross-chain network 102 enables greater efficiency, scalability, and flexibility for blockchain applications.

The property tokenization system 100 can be implemented to form a decentralized finance (DeFi) platform that can be used to facilitate selected trading activities. The illustrated property tokenization system 100 can include a liquidity pool 104. The liquidity pool 104 can represent a collection of funds, assets or property that can form part of the DeFi platform that is used to facilitate trading activities. The DeFi platform formed by the property tokenization system 100 can be a type of financial network or system that is built on top of the blockchain networks 12 and operates in a decentralized manner, without the need for intermediaries, such as banks or financial institutions. In the property tokenization system 100, financial transactions are conducted using cryptocurrencies or digital assets, and the system is governed by a set of smart contracts that are enforced by the blockchain networks 12. The property tokenization system 100 can implement and handle various financial services, such as lending, borrowing, trading, swapping, and investing, all of which can be conducted in a transparent and secure manner on the blockchain networks 12. The liquidity pool 104 enables investors 106 to trade, swap or borrow cryptocurrencies without the need for a traditional centralized exchange or market maker. In the liquidity pool 104, the investors 106 deposit funds into the pool, such as via smart contracts 13A, 13B on the blockchain networks 12A and 12B, which automatically executes trades according to pre-set parameters. The smart contracts can determine the price of the assets in the pool based on economic principles, such as supply and demand or preset or dynamic prices, and trades are executed based thereon. The liquidity pool 104 can be used in the property tokenization system 100 to provide the necessary liquidity for purchasing, selling, trading, borrowing, and swapping to occur. The liquidity pool 104 can also be used in other DeFi type platforms, such as lending and borrowing systems, to ensure that there is sufficient liquidity for users to access the funds in the liquidity pool 104, as needed. As shown, the liquidity pool 104 can include property, such as investable assets including cryptocurrency, that can be stored on one of the blockchain networks, such as for example on one or more of the blockchain networks. The user or investor 106 can retrieve assets, such as cryptocurrency, from the liquidity pool 104 and can store the cryptocurrency on the blockchain network 12A. The property can be tokenized by the property tokenization system 100 to form a property asset 108 in the form of a token or some other type of digital asset representative of a real-world asset. The property asset 108 can be conveyed to and stored in the blockchain network 12B. Similarly, the rental income 110 that is generated by the property can also be stored in the blockchain network 12B.

The blockchain networks 12 of the property tokenization system 100 can also employ various types of smart contracts 13 to execute and store different types of digital assets. For example, the blockchain network 12B can employ a smart contract 13B that communicates with other smart contracts, such as the smart contract 13A of the blockchain network 12A. The smart contracts are self-executing computer programs that runs on the blockchain networks and serve as a digital agreement between two or more parties that are automatically enforced by a computer program, without the need for intermediaries or trusted third parties. The smart contract 13B can communicate with an optional token storage and management unit, such as a token vault 112. The token vault can be any selected structure or functionality and can include a smart contract that manages the storage, trading, and liquidity of the ownership tokens. Specifically, the token vault 112 can be implemented as a smart contract that holds or stores tokens on behalf of the investor 106 and allows the tokens to be withdrawn or transferred as needed. The token vault 112 can function as a centralized storage location for the tokens, which can be accessed only by authorized parties through predefined rules and procedures implemented by the smart contracts. Alternatively, the token vault 112 can identify the users or holders of the ownership tokens. The smart contract 13B can also communicate with an optional property storage device, such as a property vault 114, which can be a type of smart contract used to securely store the digital assets 108 that represent real-world assets, such as real estate, art, commodities, and the like. In the property vault 114, each digital asset is represented by a unique digital token, which is stored on the blockchain and can be transferred between users or investors 106 in a peer-to-peer manner. The digital tokens are created using smart contracts 13A, 13B that define the ownership and transfer rules for the underlying assets and can be backed by legal agreements that ensure the validity and enforceability of the tokens. Further, the smart contract 13B can communicate with an optional rent storage unit, such as a rent vault 116, for storing the rental income 110. The rent vault 116 can also be implemented by the smart contract 13B to securely manage rental agreements and rental income between parties. The rent vault 116 can also be configured to optionally provide a decentralized platform for renting out properties, cars, or other assets, or storing and distributing rental income without the need for intermediaries or trusted third parties. The rent vault 116 can define the rental period, the rental fee, the security deposit, the portion of rental income proceeds that the investor 106 receives, and other terms and conditions of the agreement.

The blockchain network 12B can communicate with an off-chain network 120. The off-chain network 120 can be a decentralized network, such as an Oracle network, that enables the smart contract 13B on the blockchain network 12B to securely access data and services that exist outside of the blockchain, often referred to as off-chain data. The off-chain network 120 can employ a network of external digital agents (e.g., chainlinks) for collecting and verifying data from various sources, such as websites, APIs, and databases, and then send the data to the blockchain network 12B in a format that the smart contract 13B can understand and process. The off-chain network 120 can communicate data with a first external digital agent, such as an autonomous virtual machine (AVM) agent 122, which can be a cloud-based virtual machine that is designed to operate autonomously, that is, the AVM agent 122 is capable of self-patching, self-tuning, self-securing, and self-diagnosing. The AVM agent 122 can reduce the amount of time and effort required to manage and maintain virtual machines, as the agent can eliminate many of the routine tasks associated with managing virtual machines, such as patching, backup, and recovery. The AVM agent 122 can optionally incorporate one or more machine learning techniques to enable the AVM agent 122 to learn from past performance and behavior, thus enabling the AVM agent to become more efficient and effective over time.

The external digital agents of the off-chain network 120 can also include a second external digital agent, such as a Know Your Customer (KYC) agent 124, to help the property tokenization system 100 with regulatory requirements for customer identification and verification. The KYC agent 124 helps automate the user or investor onboarding process by capturing and validating investor information, conducting risk assessments, and verifying the identity of the investors. The KYC agent 124 can also serve as a centralized repository of investor data and documents, enabling organizations to easily track and manage investor information over time.

The property tokenization system 100 can also employ one or more data aggregation processes 130 for aggregating data, such as financial and property related data, and then storing the data in the storage element 132. The purpose of the process 130 is to store transitional data that can be used by the trusted chainlink. The property tokenization system 100 can also include or access a website 134 that can retrieve data for storage in the storage element 132. The information from the website 134 can also be conveyed to the smart contract 13A of the blockchain network 12A. The smart contract 13A can be a bridge smart contract to connect different blockchain networks, such as the blockchain network 12B, and facilitate interoperability between the blockchain networks. The smart contract 13A can function as a bridge between the blockchain networks 12A and 12B, thus allowing for the transfer of assets and data therebetween. The bridge smart contract 13A can be configured to lock up or secure tokens on the blockchain network 12A from the investor 106 and issue equivalent tokens on another blockchain network, such as blockchain network 12B. The bridge smart contract 13A can also be used to transfer other types of data, such as messages or transactions, between the blockchain networks. The website 134 can also send information to a vendor 136, so as to provide a way to validate the identity of the user. This can be achieved by Know Your Customer (KYC) techniques. The validation information generated as part of the KYC technique can be stored in the storage unit 132, so that the information can be later provided to the chainlink 120.

The property tokenization system of the present invention can generate tokens based on the underlying property, such as real estate, company shares, and the like. The tokens can thus function, in one embodiment, as securities. As such, the property tokenization system requires that the identity of the token owners or investors 106 be always known. Each investor 106 can perform or complete a Know Your Customer (KYC) compliance protocol or technique before being able to purchase the tokens. The KYC protocol is an investment industry standard that ensures that investment advisors or the enterprise know detailed information about the investor, including risk tolerance, investment knowledge, financial position, and the like. KYC compliance protects both investors and investment advisors. The investors are protected by having their investment advisor know what investments best suit their personal situations. Investment advisors are protected by knowing what they can and cannot include in their client's portfolio. KYC compliance typically involves requirements and policies such as risk management, customer acceptance policies, and transaction monitoring. The user can then sign the purchase contract with the company that holds the asset, and as implemented by the property tokenization systems of the present invention.

The property tokenization system of the present invention can be configured to employ a whitelisting mechanism or technique that includes a list of selected properties, enterprises, users, addresses, and the like, that are granted permission to access and to participate in certain blockchain network activities, while also excluding others. The whitelisting mechanism is hence a security mechanism used to limit access to the blockchain network 12 of the property tokenization system to only those enterprises or users that have been explicitly granted permission. In other words, the whitelisting mechanism includes or provides a list of approved enterprises or users that are allowed access to the property tokenization system. As such, the whitelisting mechanism is in essence a cybersecurity strategy that only allows an approved list of applications, programs, websites, IP addresses, email addresses, IP domains, property addresses, user names, and the like, to run in a protected computer or network, such as in the system. The users can only access applications or take actions with explicit approval by the system. Anything outside of the list is denied access. The whitelisting mechanism can be implemented in the property tokenization system by employing one or more permissioned blockchains employing one or more smart contracts that only allow selected enterprises (e.g., addresses) access to the blockchain network, one or more consensus techniques, or one or more types of access controls. In a permissioned blockchain, access to the blockchain network can be controlled and limited to a specific group of enterprises or users who have been granted permission. In consensus techniques, such as Proof of Authority (PoA) techniques, a pre-approved set of validators or nodes 14 can participate in the consensus process. In this case, a whitelist of approved validators can be maintained and used to determine which nodes are allowed to participate in the consensus process. The access controls can be implemented at the network level to restrict access to certain network activities or features. With regard to whitelisting of a new property address, users initially start with the user wallet 20. After a selected period of time (e.g., a few months), the investor or user may wish to add a layer of security by sending the tokens to a new ledger address. The users can make a request through the system 10 to enable the new address in order to always know in real time who owns the tokens. In this case, the customer does not need to re-sign the contract with the system since the customer has already done so when originally purchasing the tokens.

The property tokenization system can also be configured to allow the user to purchase tokens of old properties on a secondary market. Currently, users or investors can apply for a whitelisting of a selected number of properties per week. The user makes the request through any suitable user interface and the system forwards through the user interface any associated contract to sign. The number of contracts correspond to the number of properties. Once the contracts are executed, the system updates any associated smart contract so that the client can trade with the tokens on the secondary market or on an alternate market. The system can also employ a smart contract-mediated process that de-whitelists whitelisted users who do not hold tokens, in the event the token contract reaches a given threshold of token holders or other preset or predetermined limits.

The property tokenization system of the present invention can also be configured to collect funds or assets from the users or investors that can be employed as a form of rental property insurance to cover the risks associated with renting a real estate asset over an extended period of time. The rental property insurance aspect can include coverage for property damage, liability costs, and loss of rental income for landlords renting the property. As such, rental property insurance is a safeguard against the financial risk associated with tenants renting the property. The rental property insurance coverage can vary, but the insurance policies can cover the dwelling or structure of the property, contents of the property belonging to the landlord, liability coverage, and loss of rental income. Much of the coverage can be similar to that of traditional homeowners' insurance.

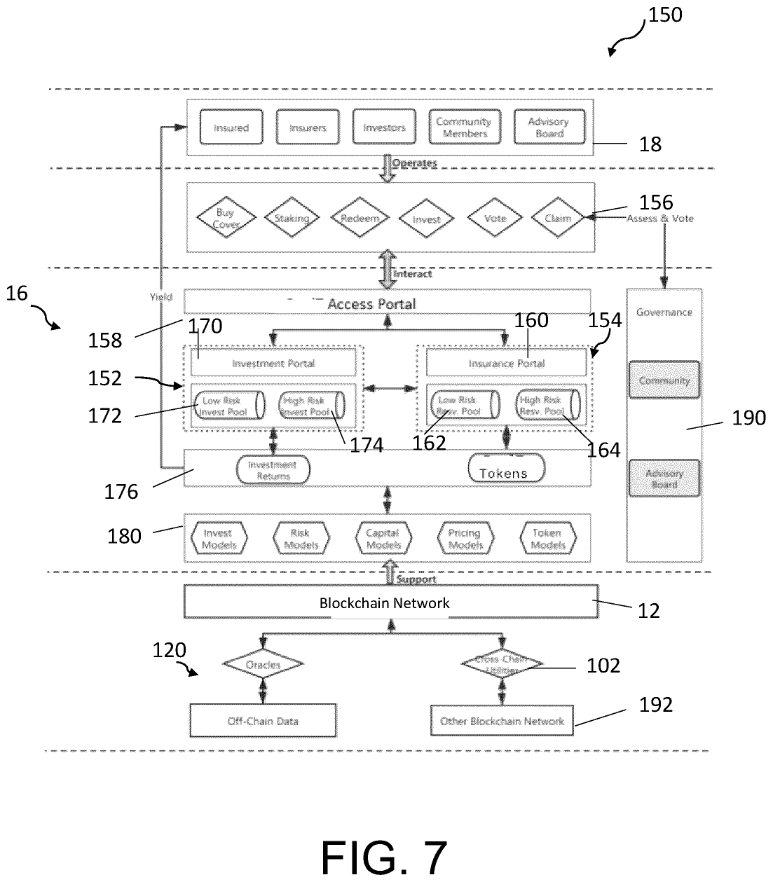

As shown in FIG. 7, the property tokenization system 150 of the present invention controls, manages or creates rental insurance and portfolios of rental insurance policies by utilizing insurance liquidity pools in the blockchain network 12, where stakeholders or investors can stake selected amounts of currency, including fiat currency and cryptocurrency, to cover property damage or loss of rent, as a form of decentralized finance (DeFi) insurance, in exchange for obtaining interest from the staked amount. The users in the tokenized real estate can purchase rental insurance for a given price that can be automatically distributed to the stakeholders or investors in the liquidity pools. According to one embodiment, a user of the user device 18 can purchase rental property insurance for tokenized real estate from the tokenized real estate platform 16. The user can purchase the rental property insurance along with an ownership token or after purchase of the ownership token corresponding to the real estate property.

Specifically, the property tokenization system 150 allows the users employing the user device 18 to communicate with and transfer assets, such as funds (e.g., cryptocurrency), to the blockchain network 12 and into one or more of the associated liquidity pools 152 and 154. The users can include investors, stakeholders, insurers, the insured members, community members, advisory board personnel, and the like. The illustrated property tokenization system 150 can include an operations layer 156 for managing selected financial and insurance operations between the user device 18 and the tokenized real estate platform 16 associated with the blockchain network 12. For example, the operations layer can be configured to handle financial operations, including investing digital assets, staking digital assets, redeeming digital assets, buying or covering digital assets, submitting claims to the system, voting on selected matters (e.g., governance), and the like. The tokenized real estate platform 16 can include an access portal 158 that allows the users to communicate with an investment liquidity pool 152 and an insurance liquidity pool 154 of the tokenized real estate platform 16. The digital assets, such as cryptocurrency, which is provided to the tokenized real estate platform 16 by the users, can be distributed to one or more of the insurance liquidity pool 154 and the investment liquidity pool 152. According to one embodiment, the cryptocurrency can be initially conveyed to the insurance liquidity pool 154. The insurance liquidity pool 154 can include an insurance portal 160 that helps distribute the cryptocurrency between multiple different reserve pools, such as a low-risk reserve pool 162 and a high-risk reserve pool 164. The reserve pools 162, 164 can correspond to funds set aside by to cover potential losses or expenses that are associated with the real estate and can be processed to create one or more portfolios of insurance products. As used herein, the term “insurance product” means or refers to a financial contract between an insurer, such as the property tokenization system, and a policyholder, such as the user or investor, that is designed to provide protection against property specific risks in exchange for payment of a selected amount of currency (e.g., fiat currency or cryptocurrency), and which forms an insurance premium. The insurance product sets forth the terms and conditions of the insurance coverage, including the scope of the risks covered, the amount of the premium, the policyholder's obligations, and the insurer's responsibilities. The distribution of the cryptocurrency between the reserve pools 162 and 164 in the insurance liquidity pool 154 can be performed according to selected financial and investment techniques. For example, the cryptocurrency can be distributed between the low-risk reserve pool 162 and the high-risk reserve pool 164 based on one or more risk related attributes of the real estate associated with the investments. The risk related attributes can include market risk which refers to a potential for a decrease in a value of the property due to changes in the local, regional, or national economy; liquidity risk meaning that the real estate cannot be easily converted to cash; interest rate risk which relates to potential changes in interest rates that can impact the cost of financing the real estate; location risk which can impact the value and demand of the real estate; property condition risk; tenant risk which is related to the potential default on rent payments by tenants or property damage; regulatory risk which relates to potential changes in the regulatory environment that can impact property values and profitability; environmental risk such as contamination or flooding; legal risk which relates to potential legal disputes over ownership of the real estate, zoning law changes, and the like; and tax risk which relates to potential changes in the tax laws.

The property tokenization system 150 can also distribute a selected amount of the cryptocurrency from the insurance liquidity pool 154 to the investment liquidity pool 152. A selected amount of the capital in the insurance liquidity pool 154 can be moved or placed into the investment liquidity pool 152 to gain higher yield, while the insurance liquidity pool 154 provides protection to the investment activities. The yield on the assets in the investment liquidity pool 152 can complement the premiums or assets in the insurance liquidity pool to reduce the costs for users and investors. The increase in the assets in both liquidity pools can be returned to the shareholders or can be employed to cover costs. The investment liquidity pool 152 enables the system to invest a selected amount of the cryptocurrency set aside in the insurance liquidity pool 154 into selected investment vehicles in order to generate income from the insurance proceeds. The investment liquidity pool 152 can include an investment portal 170 that helps distribute the cryptocurrency between a low-risk investment pool 172 and a high-risk investment pool 174 based on one or more selected investment attributes, including investment goals and objectives, risk profiles associated with the investments and the risk goals of the pool, time span for investments, diversification preferences and requirements, historical performance of the actual or proposed investments, fees associated with the investments, and the like. The distribution of the cryptocurrency between the investment pools 172 and 174 can be performed according to selected financial and investment techniques. For example, the assets in the low-risk investment pool 172 are typically invested in low-risk, highly liquid investments, such as government bonds or money market funds, to ensure that the funds are readily available when needed. The assets in the high-risk investment pool 174 are typically invested in riskier investments, such as equities or alternative investments, that have the potential for higher returns but also carry higher levels of risk. The tokenized real estate platform 16 can also include a product layer 176 for determining investment returns, for handling the conveyance of tokens, and the like.

The illustrated property tokenization system 150 can also include a model layer 180 that communicates with the tokenized real estate platform 16 as well as with the blockchain network 12. The model layer 180 can apply one or more modeling techniques to the information stored in the tokenized real estate platform 16, as well as to the information or data received from the blockchain network 12. The modeling techniques can include investment models, risk models to assess and quantify potential risks associated with certain investment activities or decisions (e.g, value-at-risk models, Monte Carlo simulations, credit risk models, market risk models, operational risk models, and the like), capital models to determine the amount of capital needed to absorb potential losses and maintain solvency (e.g., basel accords, internal capital models, insurance risk models, stress testing models, economic capital models, and the like), pricing models for estimating or determining the value or price of financial instruments or assets to determine fair prices, make informed investment decisions, and manage risks (e.g., discounted cash flow models, capital asset pricing models, Black-Scholes models and the like), token models to assist with design and structure of the tokens (e.g., utility tokens, security tokens, governance tokens, stablecoins, non-fungible tokens, and wrapped tokens), and the like.

The property tokenization system 150 can also include a governance unit 190 that communicates with the operations layer 156 to allow the users to perform one or more governance related activities. The governance related activities on the blockchain network 12 refer to the processes and mechanisms by which decisions and changes are made to the protocol, rules, and operation of the blockchain network. The governance related activities can involve the participation of stakeholders in proposing, discussing, and implementing modifications to the blockchain's parameters, consensus rules, smart contracts, and other essential components. For example, the governance related activities can include protocol updates including proposing and voting on changes, consensus mechanisms to validate transactions and add them to the ledger, network management activities including maintaining the network infrastructure, managing nodes and validators, monitoring network performance, and resolving technical issues that arise, designing and implementing token distribution, community management activities including facilitating communication and collaboration among stakeholders, resolving disputes and conflicts, and ensuring transparency and accountability in decision-making, and security and risk management activities including implementing security measures such as encryption and multi-factor authentication, conducting security audits, and developing disaster recovery plans. The governance unit 190 can thus set forth the rules and protocols that manage and regulate the operation of the blockchain network 12 and creates the framework for decision-making within the network. As such, the governance unit 190 can be responsible for managing various aspects of the blockchain network 12, such as determining which transactions are valid or should be permitted (e.g., whitelisting), how the network is upgraded, how disputes are resolved, and sets the rules for the creation and distribution of new and existing tokens, if applicable. In the blockchain network 12, governance can be managed by a community of stakeholders, who can include node operators, developers, token holders, and other interested parties. The stakeholders work together to make decisions through a process of consensus, which may involve voting or other forms of decision-making. The blockchain network 12 can also communicate with an off-chain network 120. The off-chain network 120 can be a decentralized network, such as an Oracle network, that enables the smart contract on the blockchain network 12 to securely access data and services that exist outside of the blockchain network 12. The blockchain network can also communicate with the cross-chain network 102. The cross-chain network 102 can be a network that enables the blockchain network 12 to communicate with another blockchain network 192 by using a selected communication protocol. The cross-chain network 102 enables different blockchain networks to exchange data, assets, or tokens without the need for intermediaries.

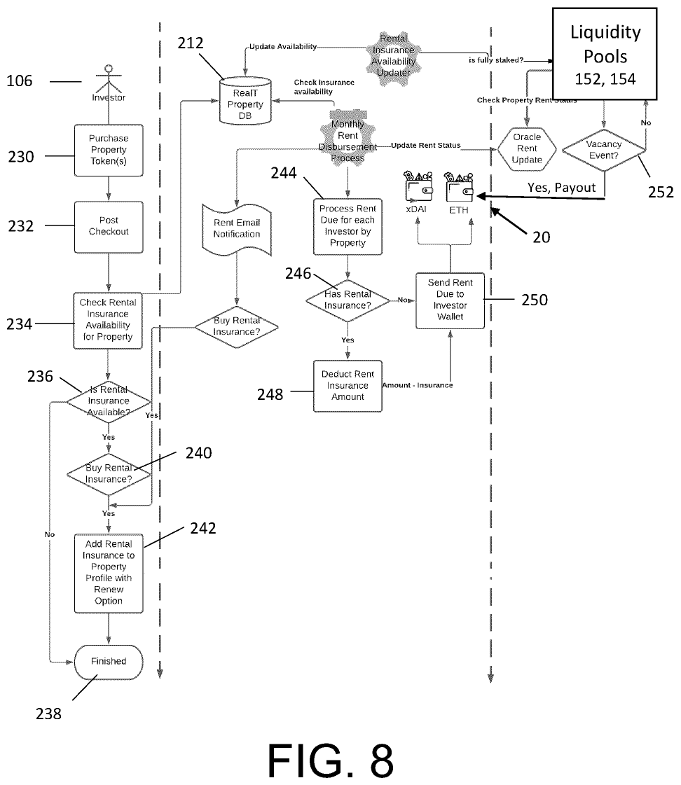

By simple way of example, and with reference to FIGS. 7-9, the user, as an investor 106, can purchase one or more ownership tokens associated with the real estate asset that is generated or created by the property tokenization system, step 230. The investor 106 can then checkout or confirm that purchase and receipt off the ownership tokens, step 232. The investor 106 can then check the availability of any rental property insurance, step 234. The property tokenization system 150 can check a database 212 of insurance products to determine the availability of the requested or desired insurance products. The database 212 can be updated to reflect the currently available insurance products. The property tokenization system 150 can then determine, based on user specifications, if a suitable insurance product, such as rental property insurance, is available, step 236. If the insurance product is not available for purchase by the investor, then the determination and user inquiry is completed, step 238. If the system determination is that a suitable insurance product is available for purchase, then the investor 106 can purchase the insurance, step 240. Specifically, the investor 106 can secure rental property insurance by sending a selected amount of cryptocurrency to the tokenized real estate platform 16 as an insurance premium. The insurance premium can be determined by the system, such as by the operations layer 156. The rental insurance product information can then be added to the user profile, and if the insurance policy has an auto renew option, then the renewal information can also be provided, step 242.

The insurance premiums paid by the investor 106 can be allocated to one or both of the insurance liquidity pool 154 or the investment liquidity pool 152. According to one practice, the cryptocurrency is initially allocated to the insurance liquidity pool 154, and then a portion of the accumulated cryptocurrency in the insurance liquidity pool 154 can be allocated to the investment liquidity pool 152. The funds in the insurance liquidity pool 154 can then be allocated between the low-risk reserve pool 162 and the high-risk reserve pool 164. The reserve pools serve as funds that are set aside to cover potential losses or unexpected expenses. The low-risk reserve pool 162 can include funds that are invested in low-risk, conservative investments, such as cash, high-quality bonds, or other stable fixed income securities. These types of investments are less likely to experience significant price fluctuations and are more stable and reliable over the long term. The low-risk reserve pool 162 helps preserve the value of the funds and provide a source of liquidity in case of emergency or unexpected expenses. The high-risk reserve pool 164 can include funds invested in riskier, more volatile investments, such as stocks, real estate, or alternative investments such as hedge funds or private equity. These types of investments carry a higher level of risk and are more likely to experience significant price fluctuations. The high-risk reserve pool 164 helps generate higher returns over the long term, but at the cost of greater risk.

The portion of the insurance premiums allocated to the investment liquidity pool 152 from the insurance liquidity pool 154 can be invested to increase the value or size of the liquidity pools. For example, the interest from the liquidity pools 152, 154 can help pay the users (e.g., investors) that have invested in the liquidity pools. Like traditional insurance products, the tokenized real estate platform 16 allows for capital or investments to move between the capital investment like liquidity pool 152 and the insurance liquidity pool 154 so as to increase earnings for the stakeholders. Specifically, the free capital in the insurance liquidity pool 154 can be placed into the investment liquidity pool 152 to gain a higher yield, while the insurance liquidity pool provides protection to the investment activities. Meanwhile, the yield on the investments in the investment liquidity pool can in turn complement the premiums paid into the insurance liquidity pool, and further reduce the cost for investors. Thus, the liquidity pools provide a low-cost premium insurance as well as investment return for the investors. Further, the rental insurance focus of the tokenized real estate platform 16 can generate revenues from the insurance premiums as well as from the investment returns. The combined revenues can be used in areas such as operation/development costs, community incentives, ecosystem collaborations, and the like.

The smart contract associated with the blockchain network 12 can automatically make insurance premium payments to relevant ownership token holders in response to the occurrence of a covered insurance event. As used herein, the term “covered insurance event” or “insurance event” is intended to refer to an occurrence or situation that is included in the terms and conditions of an insurance policy or product, and for which the insurance company is obligated to provide coverage and compensate the policyholder. The specific types of events that are covered by an insurance policy depend on the type of insurance and the policy's specific terms and conditions. For example, in a rental insurance policy, covered events can include missed rental payment by a tenant, vacancy, damage to the property, and the like. The rent proceeds accumulated by the property tokenization system can be placed into one or more of the liquidity pools. The property tokenization system can process the rent proceeds, step 244. The system can then determine of the specific investor has acquired or purchased rental insurance, step 246. If the investor 106 purchased the rental insurance, then the premiums that are due to be paid to the investor are deducted from the any proportional amount of the total proceeds that are due to be given to the investor, step 248. The proceeds can then be conveyed to the investor, step 250. The proceeds can be stored in the digital wallet 20. The property tokenization system can also determine if a covered insurance event, such as a vacancy or missed rental payment, has occurred, step 252. If it has, then payouts to the investor from the liquidity pools can be conveyed to the investor's wallet 20.

The property tokenization system 150 can employ the tokenized real estate platform 16 to handle and store tokens and cryptocurrency paid by the investors. As such, the property tokenization system 150 forms, in essence, an insurance DeFi platform. Further, the payment of the cryptocurrency as a replacement or substitute for traditional insurance premiums forms a decentralized insurance protocol to manage the risk associated with protecting the real estate. The investor 106 can stake cryptocurrency by holding cryptocurrency in the cryptocurrency wallet 20 for a fixed period of time (e.g., holding period). The investor can earn interest or rewards during the holding period. The DeFi platform implemented by the property tokenization system 150 offers portfolio-based insurance for real estate rentals with optimized pricing models to substantially lower the cost of real estate rental insurance and can employ solvency capital requirements (SCR) mining programs to create sustainable returns for the stakeholders.

The DeFi rental insurance platform implemented by the property tokenization system 150 can help expand accessibility of the system by removing Know Your Customer (KYC) restrictions and requirements. Any user with a digital wallet 20 can connect with the tokenized real estate platform 16 and use the services, such as buying the tokens, investing cryptocurrency in insurance, staking cryptocurrency assets, making claims, and the like. Another advantage of the DeFi rental insurance platform of the present invention is the solvency capital requirements mining programs. The users are able to earn a protocol token by staking into the liquidity pool using, for example, Ethereum, DAI stable coin, fiat currency, and the like. The capital injected through staking into the platform can be managed with rigorous risk control models to dynamically adjust the solvency capital requirement and use the secured free capital for further investment. Further, in the DeFi rental insurance platform of the present invention, the stakeholders can gain returns in additional ways, including investing directly in other DeFi protocols, stake in the mutual pool to receive reward tokens, and the like.

Another advantage of the property tokenization system 150 of the present invention is that the system can provide covers on smart contracts, at the start, which is the most demanding portion in current DeFi platforms. That is, the property tokenization system 150 can handle insurance or protection against potential losses that may occur as a result of a smart contract malfunction or attack by providing appropriate insurance. The DeFi rental insurance platform of the property tokenization system 150 can also adopt a portfolio-based design to pool all injected real estate assets into one or more pools and provide multiple protocol protection together. The liquidity pools 1562, 154 aggregating funds from the investors 106 can be configured as a plurality of portfolios of insurance products where the investor can choose one or more portfolios or insurance products, request an insurance quote, and place an order on the tokenized real estate platform 16, which is flexible and direct. Alternatively, the investor 106 can access preconfigured portfolios of insurance products categorized or classified according to different criteria, such as business type and risk level. The tokenized real estate platform 16 via the operations layer 156 can provide, if desired, a risk score associated with selected portfolios for use by the users. The tokenized real estate platform 16 can employ community members, with voting rights, that can vote to add or remove selected portfolios on the platform. Specifically, the property tokenization system 150 can properly price the insurance products in the various portfolios forming part of the insurance liquidity pool 154. The portfolios can have one or more protocols associated therewith. As used herein, the term “protocol” or “insurance protocol” refers to a set of rules and standards that govern how insurance transactions are conducted on the blockchain network 12 and in the tokenized real estate platform 16 of the property tokenization system. The protocols define the terms and conditions of insurance contracts, the process for submitting and adjudicating claims via the operations layer 156, and the parameters for calculating insurance premiums and payouts. The protocols can be implemented by the smart contracts, which allows for the automation of insurance transactions without the need for intermediaries. For example, the smart contracts of the blockchain network 12 can be used to automate the issuance of insurance policies, the verification of claims, and the calculation and disbursement of payouts. The DeFi rental insurance platform implemented by property tokenization system 150 of the present invention can substantially can employ an actuarial based pricing model to properly assess or determine the expected loss of insurance products, and thereby reduce the cost and enhance the capability of the platform.

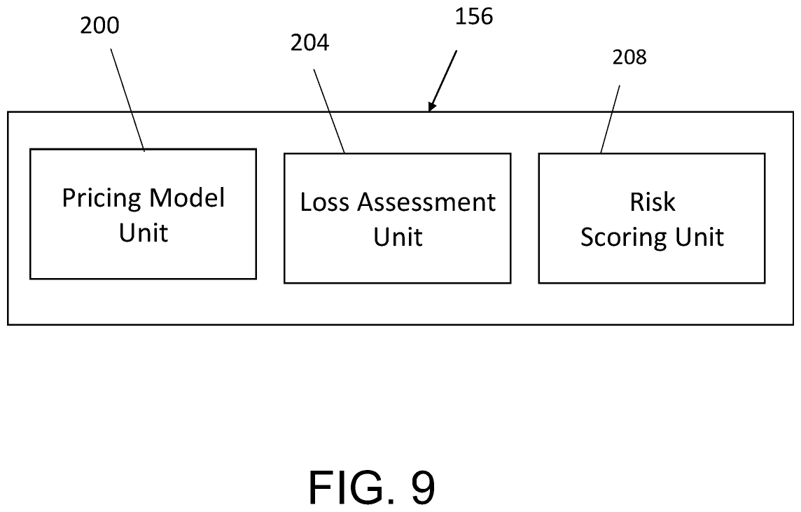

For example, as shown in FIG. 9, the operations layer 156 can include a pricing model unit 200 for applying one or more actuarial based pricing models to the portfolio of insurance products stored in the insurance liquidity pool 154 to determine a pricing model that estimates a likelihood and a potential cost of future claims and sets the insurance premiums for each portfolio. As such, the pricing model unit 200 can be used to assess the risk associated with insuring specific assets or individuals and to determine the appropriate insurance premiums. The actuarial-based pricing model considers various insurance related factors, such as historical claims data, the probability of a claim occurring, the potential cost of a claim, and the overall risk level of the asset, such as real estate, being insured. The actuarial-based pricing model employed by the pricing model unit 200 can help ensure that insurance premiums are fair and appropriate for the level of risk being insured. Actuarial science employed by the actuarial-based pricing model provides a rigorous and data-driven approach for pricing insurance, which can help increase transparency and trust in the insurance process.

The loss assessment determined by the operations layer 156 can be conducted on the insurance portfolio level. Specifically, the operations layer 156 can include a loss assessment unit 204 for evaluating, assessing or determining a risk level of one or more portfolios of insurance products and assessing any potential losses that can occur in the event of a significant loss event. As used herein, the term “risk level assessment” or “assessing risk level” or “risk level” is intended to refer to or mean the ability to evaluate a likelihood and potential severity of losses that may occur within a particular group or portfolio of insurance products or policies. The risk assessment involves analyzing various factors, such as the nature of the insured assets or activities, historical claims data, and external market and economic conditions, in order to identify potential sources of risk and quantify their potential impact on the financial resources or levels in the liquidity pools. The ability to assess the risk level ensures that a balanced and profitable portfolio of insurance products are maintained within the insurance liquidity pool by appropriately pricing premiums and managing the exposure to risk. In the blockchain insurance environment, where insurance products and transactions are recorded on the blockchain network 12, the loss assessment unit 204 can thus efficiently and accurately conduct a portfolio level, risk level assessment. The insurance portfolio related data can include information about the insurance policies and products forming part of the insurance liquidity pool 156, where the related policy information (e.g., policy holder information, coverage information, policy information, insured asset information, premium data, payment data, claims data, and the like) is stored on the blockchain network 12. The loss assessment unit 204 can thus help identify the level of risk of a portfolio of insurance products or of individual insurance products, such that the property tokenization system can manage the overall level of risk.

Further, the operations layer 156 can employ a risk scoring unit 208 for analyzing the portfolios of insurance products and for determining and assigning risk scores for each portfolio of insurance products or for each individual insurance product within the portfolios. Specifically, the risk scoring unit 208 can be configured to employ an Aggregate Loss Distribution (ALD) model to estimate an expected loss in an insurance portfolio. The ALD model is a statistical model that can estimate a distribution of aggregate losses that a portfolio of assets or liabilities, such as a portfolio of insurance products or policies, can incur over a given period. The ALD model employed by the risk scoring unit 208 can consider the distribution of losses for each asset or liability (e.g., insurance products) in the portfolio, as well as a correlation between the assets. There are several types of ALD models, including parametric, non-parametric, and semi-parametric models. The risk scoring unit 208 can process a number/amount of claims and a number/amount of exposures in a given time window, which can be used for selecting and training the ALD model. The ALD model can preferably employ a frequency model and a severity model. The frequency model is a model that estimates the number of claims that are likely to occur over a given period of time by considering one or more claim related factors, such as the historical frequency of claims, the underlying risk factors that contribute to losses, and any changes in the insurance environment that can impact claim frequency. The severity model can be used to estimate the monetary size of each claim by considering one or more loss related factors, such as the historical severity of losses, the types of assets or events being insured, and any changes in the economic or environmental conditions that could impact claims severity. As such, the severity model can produce a distribution of loss amounts as well as set the level of deductible and limit of the coverage amount. By combining the estimates from the frequency model and the severity model, an ALD model can estimate the overall loss distribution of an insurance portfolio (e.g., aggregate loss). Once the aggregate loss is determined by the ALD model employed by the risk scoring unit 208, the operations layer 156 can utilize the risk scores when determining a final insurance premium. Once the ALD model has been calibrated, the risk scoring unit 208 can be used to determine a risk score for each portfolio. The risk score represents the probability distribution of total losses that the portfolio may face due to different types of risks. The risk score can be used to manage the risk exposure of the portfolio and to develop appropriate risk mitigation strategies.

The investors who stake tokens, such as ERC-20 tokens and DAI stable coins, and other eligible tokens, into the tokenized real estate platform 16 can receive selected cryptocurrency, such as DAO tokens, in return as incentives (e.g., mining). The property tokenization system 150 (e.g., DeFi rental insurance platform) can include both insurance and investment sides or pools where investors can stake capital on both sides, and the tokens can be mined and controlled by the following equation (Equ. 1):

Speed(Investment)+Speed(Insurance)=C Equ. 1

where C is a constant determined by the token economy adjusted over time. The Equ. 1 can create a balance between the insurance and investment functions of the tokenized real estate platform 16. When the insurance liquidity pool 154 has insufficient funds to handle or cover actual or expected losses, which poses higher risks and raises the premiums, the mining speed on the insurance side can be increased to attract more capital to the insurance liquidity pool 154. Similarly, once the insurance liquidity pool 154 has sufficient funds, the mining speed on the investment side can be increased to attract more investment funds. Mining speed on a blockchain refers to the rate at which new blocks can be added to the blockchain. The balance is driven by a solvency capital requirement (SCR) mining mechanism. The solvency capital requirement can correspond to an amount of funds that insurance and reinsurance companies are required to hold in order to have a selected degree of confidence that the enterprise, represented by the system, can survive extreme expected losses over a selected period of time. The SCR mining mechanism is configured to dynamically adjust the mining speed among the insurance liquidity pool and the investment liquidity pool according to a capital sufficiency status represented by a SCR ratio, incentivizing more capital staking to the less staked pools represented by the SCR ratio, which helps reduce the premium on new or high risk protocols as a whole. The mining speed can be changed to normal when the SCR ratio is equal to or above the platform defined SCR ratio. The SCR ration can be determined based on a 99% solvency within a selected period of time, such as 12 months.

The claim assessment aspect of the DeFi rental insurance platform of the present invention can rely on a community of claim assessors and an advisory board. The claim assessors need to meet a minimum requirement of stake. Instead of a simple accept/reject result type voting protocol, the DeFi rental insurance platform of the present invention can introduce a quantitative method to handle the claim. Specifically, the tokenized real estate platform 16 can be configured to include a claim assessment unit that receives from a claimant (e.g., investor) a claim application, the advisory board can investigate the claim, and then propose a claim amount for settlement. For example, 0% represents a rejection of the claim, 100% represents a full compensation, and another ratio between 0% and 100% represents a partial compensation offer. The proposal is then submitted to the community for DAO token-based decision making. The proposal is subject to voting by the community members with staking in the insurance pool. If, for example, the threshold vote total to reach a predefined consensus level, such as for example 75%, then the assessment outcome is determined once the consensus reaches the threshold level. If the proposal fails to reach a consensus, the proposal is subject to voting by the community members with selected token holdings, no matter whether they have staked in the insurance capital pool or not. The outcome is settled once a consensus is reached. If the proposal still fails, the proposal can be determined at the sole discretion of the advisory board to provide the final result. Once the above processes are rolled out with an outcome, the DeFi rental insurance platform can issue the claim to the applicant and all associated data is disclosed to the participants.

In another embodiment of the present invention, the tokenized real estate platform 16 forming part of the property tokenization system can be employed to increase liquidity of the real estate assets. The property tokenization system enhances the overall market for the real estate tokens providing for overall market liquidity. Absent a market or buyer for the tokens, the property tokenization system enables the issuer of the tokens to purchase (e.g., buy back) the tokens. The tokenized real estate platform 16 can be configure to allow the token issuer to buy back an ownership token from a user of a user device 18. In one embodiment, the user can use a user interface (UI) to display the tokens owned by the user and to sell one or more ownership tokens back to the platform 16. In some embodiments, the UI can display information about the user's ownership tokens that the user currently owns. The UI can obtain this information from the blockchain. The information can include the specific real estate properties the user has purchased ownership tokens for and the number of ownership tokens for each real estate property. The UI can include a user input area (e.g., a textbox, a scroll wheel, etc.) that can allow the user to input the number of ownership tokens the user wishes to sell back to the tokenized real estate platform 16. The number of ownership tokens to sell back can include an integer or a decimal number. In response to the user inputting the number of ownership tokens to sell back, the platform 16 can calculate a buy back price. The buyback price can include the value of the ownership tokens minus one or more fees.

The UI can allow the user to submit the buyback request. The UI can include a display that can track the buyback request. The UI can include an element, such as a button, the user can interact with to cancel the buyback request. In some embodiments, the UI can include an input area so that the user can input verification information. The tokenized real estate platform 16 can use verification information to validate the buyback request. The UI can also track sell orders and buy back requests, as well as activatable soft buttons that allow the user to cancel or proceed with the purchase requests.

When the property tokenization system of the present invention tokenizes property, such as a real estate asset, the system through the tokenized real estate platform 16 provides for the application of selected fees, such as a selected expense fee to cover operating expenses. The expense fee can be integrated in the price of the token. The tokenized real estate platform 16 can be configured to revalue the price of the tokens according to any selected time frequency, such as for example daily, monthly, or yearly. Once the token is revalued, the initial fee is removed from the price of value of the token.

The governance unit 190 can be configured to generate a governance token (e.g., decentralized autonomous organization (DAO) token) in place of the original fee. The DAO generally refers to a self-governing, decentralized platform that is run by a set of rules encoded in smart contracts on the blockchain network 12. The DAO token is a type of digital token that can be used to represent ownership or membership in the DAO. The DAO token can be created and managed on the blockchain network 12 by the governance unit 190, and the value of the DAO token can be determined by the supply and demand of the market formed by the system. The DAO tokens allow users to participate in the governance and decision-making process of the DAO as community members, such as having the ability to vote on proposals or elect representatives. The token holders can also be entitled to a share of the profits or revenue generated by the property tokenization system. The ownership and transfer of the DAO tokens can be managed using smart contracts on the blockchain network 12, which ensures that the tokens are secure, transparent, and tamper-proof. The DAO token, which now functions as a real estate governance (REG) token, can be distributed proportionally to the different stakeholders. The stakeholders that hold and own the REG tokens gain the ability to vote on matters directly related to the DAO, such as the allocation of funds, DAO improvements, new members, and the like.

The property tokenization system of the present invention can also be employed to tokenize assets other than real estate, including for example shares in a company and the like. For example, each share or any selected, predefined block of shares can be tokenized and hence represented as a token. The property tokenization system allows the user (e.g., investor) through any suitable UI to view tokens for sale and to purchase the tokens. After purchase, the user executes a contract to confirm that the user becomes a shareholder of the company. The user thus owns directly one or more shares of the company. The company may indirectly own one or more other assets, including real estate, equipment, patents, token mining machines, and the like, and can redistribute the net financial proceeds pro rata to each shareholder, including the token holder. The user can purchase the tokens and sign the appropriate legal contract. With the funds raised, the company buys the underlying asset. The tokens can be sent to the user wallet 20 and distributions are paid periodically.

As described herein, the property tokenization system can be configured to tokenize property, such as real estate, shares in a company, and the like. If the property is real estate, then the system forms or creates a liquid asset from an illiquid asset. Further, since the system can tokenize assets such as shares in a company, the tokens associated with the shares can be, in essence, tokens in real estate owned by the company. The system can employ any suitable UI to allow or enable the customer to purchase and sell the tokens.

In jurisdictions outside the United States, such as Europe, the governments can levy taxes or fees on the sale of real estate. As such, the tokenized real estate may be subject to the same tax. If the value of the token makes it unwise to sell the token because the price of the token is close to or less than the price of the tax, then the property tokenization system can be configured to form a company that holds a single property. The tokens can then be considered not to represent a share in the company but can be treated as a bond that is convertible into shares. The convertible bond is not subject to the tax levy. As such, the tokens are freely exchangeable on the secondary market. At any time, the investor can exchange his token bond for a share of the company. The share will then no longer be exchangeable on the secondary market.

Today's financial loan markets operate with the help of a trusted third party or entity. The trusted party acting as a lender verifies a customer's file and grants the customer funds that are repaid over a selected period. The lender is paid an interest rate on any borrowed funds (e.g., loan) as remuneration for the risk borne by the lender in the case of non-payment.

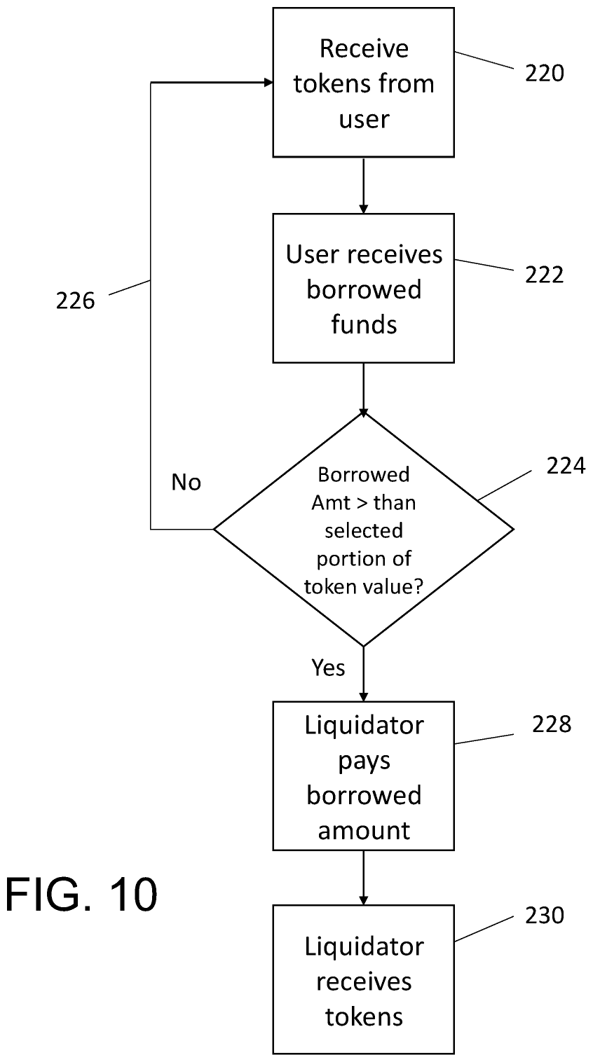

The property tokenization system of the present invention, via the blockchain network 12, can perform peer-to-peer transactions without requiring any personal information (e.g., age, financial situation, work, place of residence, nationality, etc.) of the customer. As such, the property tokenization system can be configured to trust software code once the identity of the customer is no longer required. As such, and according to another embodiment of the invention as shown for example in FIG. 10, the property tokenization system can employ the tokenized real estate platform 16 to disrupt the mortgage lending ecosystem by decreasing risk, increasing security, remove manual processes, and streamlines settlements to make transactions quick, affordable, and transparent. The tokenized real estate platform 16 can include a user interface that allows the customer to deposit real estate ownership tokens and the tokenized real estate platform is configured to receive and store the ownership tokens, step 220. The tokenized real estate platform 16 can be configured to convey or lend to the user (e.g., borrower) an agreed upon amount based on the value of the tokens stored in the platform, step 222. The borrowed amount can be in any selected form, such as in fiat currency or tokens associated with different assets. For example, the property tokenization system allows the user to borrow up to a selected percentage of the underlying value of the tokens. According to one simple example, the customer can borrow up to 50% of the value of the tokens. The system then monitors the user account to see if the user continues to borrow against the underlying asset (e.g., token) or if the value of the underlying asset decreases such that the loan amount percentage relative to the token value increases to a selected higher percentage amount, step 224. If the loan or borrowed amount is less than a selected portion of the value of the underlying asset (e.g., token), then the property tokenization system takes no action, step 226. If the amount borrowed exceeds the preselected portion of the value of the underlying asset, then the system 100 can function as a liquidator and can elect to repay the borrowed amount (e.g., outstanding loan amount), step 228, and in return receives the pledged tokens, step 230, at a selected discounted value. By simple way of example, if the loan amount reaches 70% of the value of the underlying tokens, then the property tokenization system can repay the borrower's loan and in exchange receives the pledged real estate tokens at a selected discount (e.g., 10%).

Today, selected real estate websites, such as Zillow, Trulia and the like, and the multiple listing service (MLS), allow a person or company to list real estate ads on their corresponding websites to buy or sell property. The websites also allow a buyer and a seller to begin negotiations over the property through the website. These websites, however, do not allow the person to buy a portion or fraction of the property through a convenient user interface. The economic interests of the parties involved in the foregoing process are not aligned. The seller wants to sell the property at the highest price and the buyer wants to buy the property at the lowest price. The seller may also accidentally or purposely fail to disclose meaningful information.

According to another embodiment, the property tokenization system of the present invention can employ the governance unit 190 that is configured to allow the owners or holders of the tokens to perform or take one or more governance actions, such as to vote as to whether to allow property, such as real estate, to be listed for sale in the property tokenization system. If the stakeholders vote in the negative through any suitable user interface, then the property is not listed for sale. If the vote is in the affirmative, then the property is listed for sale. In return, the sellers of the real estate can pledge a selected amount of real estate governance (REG) tokens pursuant to the terms set forth in the smart contract. The REG tokens are a type of blockchain-based digital asset that represents ownership or a stake in a real estate asset or property. The REG tokens are designed to provide a more accessible and efficient way for users to invest in real estate projects. If the seller fails to honor any commitment or obligation, then the REG tokens are retained and redistributed to the buyers as a form of compensate.

The property tokenization system of the present invention can also be configured to collect rent according to selected frequencies, such as daily, weekly or monthly, and then pay distributions to the token holders according to a predefined pay-out schedule, such as weekly. The blockchain network 12 of the property tokenization system can be configured to provide a three-party accounting system and the statements/balances are updated with each validated block in the blockchain network 12. At each block, the property tokenization system knows the identity of the owner of all tokens. The property tokenization system can then provide information associated with the eligible distribution part to the token holders at every block.

As is known, the foregoing cryptocurrency wallets 20 are digital wallets that serve to store the public and private keys of the user while providing an easy-to-use interface to manage cryptocurrency balances. The digital wallets 20 also support cryptocurrency transfers through the blockchain network 12. Some digital wallets even allow users to perform certain actions with their crypto assets such as buying and selling or interacting with decentralized applications (dapps). A cryptocurrency transaction does not necessarily represent a ‘sending’ of cryptocurrency tokens from a computing device (e.g., mobile phone) of a first user to a computing device of a second user. When a user is sending tokens, the user is using a private key to sign the transaction and broadcast the private key to the blockchain network 12. The blockchain network 12 then can include the transaction to reflect the updated balance in the addresses of the users. As such, the cryptocurrency wallet need not store cryptocurrency in the same way physical wallets hold cash. Instead, the wallet 20 reads the public ledger to illustrate or show the balance in the wallet address and also holds the private keys that enable the user (e.g., wallet owner) to make transactions.

There are various types of digital wallets 20, including a software-based hot cryptographic wallet, a physical cold cryptographic wallet (e.g., hardware wallet), and a smart contract wallet. The cold cryptographic wallet is a type of cryptocurrency wallet that stores the private keys to the digital assets offline, typically on a physical device. In contrast, the hot cryptographic wallet is a type of digital wallet that is connected to the internet and actively used for storing and managing cryptocurrencies. It is called “hot” because it is constantly online and readily accessible for transactions and interactions with the blockchain network. The main difference between the hot and cold cryptographic wallets is whether they are connected to the Internet. Hot cryptographic wallets are connected to the Internet, while cold cryptographic wallets are kept offline. This means that funds stored in the hot cryptographic wallets are more accessible, and are also easier for hackers to gain access to. Examples of hot cryptographic wallets include web-based wallets, mobile wallets, and desktop wallets. In hot wallets, the private keys can be stored and encrypted in the wallet application, which is kept online.

In addition to the wallets mentioned above, cryptocurrency wallets can be further separated into custodial and non-custodial types of cryptographic wallets. The custodial cryptographic wallet is a type of digital wallet where a third-party service provider or company holds and manages the private keys to the cryptocurrency holdings on a user's behalf. The company thus has control over the cryptocurrency. Custodial cryptographic wallets are usually offered by cryptocurrency exchanges, online wallet services, and other similar platforms. These wallets offer the convenience of easy access to your funds and a user-friendly interface. The non-custodial cryptocurrency wallet is a type of digital wallet where the user has complete control over their private keys and cryptocurrency holdings. In other words, the user is responsible for storing and securing their own cryptocurrency, rather than relying on a third-party service provider. Most web-based cryptocurrency wallets are custodial wallets. The main difference between custodial wallets and non-custodial wallets is that the users are no longer in full control of their tokens, and the private keys needed to sign for transactions are held by the exchange and not by the user. Non-custodial wallets, on the other hand, allow the user to retain full control of the tokens and funds in the wallet since the private key is stored locally with the user.

Another embodiment of the property tokenization system of the present invention replaces the digital wallet 20 with a smart contract wallet (e.g., software wallet), such as the smart contract wallet by Gnosis Safe. The smart contract wallet is a type of digital wallet that is governed by a set of rules encoded as a smart contract on the blockchain network 12. The smart contract wallets are designed to automate and simplify the execution of financial transactions without requiring a third party to act as an intermediary. In the smart contract wallet, the rules of the wallet are written in code, and the wallet automatically enforces these rules whenever a transaction is initiated. The smart contract wallet can be configured to require multiple signatures. For example, the present invention contemplates the use of a smart contract wallet that uses multiple signatures in order to execute a transaction. Specifically, the property tokenization system of the present invention can employ the smart contract wallet running on one or more blockchain networks 12 that requires a minimum number of people to approve a transaction before it can occur (e.g., M-of-N). M of N refers to a method of authorization used in cryptography and computer security. In this method, a certain number of total participants, denoted as “N”, are required to authorize a transaction or perform an action, and a subset of those participants, denoted as “M”, must give their authorization before the action can be executed. By simple way of example, if three main stakeholders form part of a business, the wallet can require approval from 2 (“M”) out of 3 (“N”) (e.g., 2/3), or all three people, before the transaction is sent. This ensures that no single person can compromise the funds associated with the wallet.

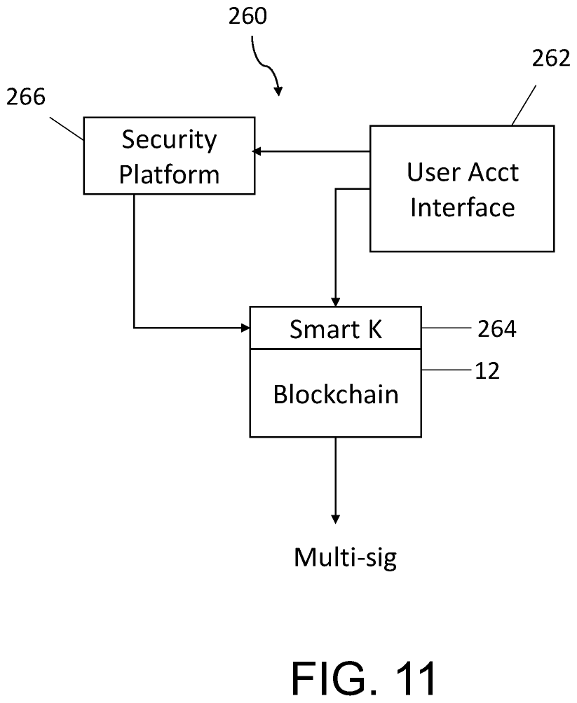

As shown for example in FIG. 11, the property tokenization system 260 of the present invention can employ the smart contract wallet. The property tokenization system 260 includes a user account interface 262 that represents a system front end and the user can create, by default, a Ox address by choosing a walletless feature with additional security functionality, such as multi-factor authentication. When employing the smart contract wallet, a request can be automatically generated by the user account interface 262 via a suitable API that is connected to the smart contract 264 in the associated blockchain network 12, thus allowing it to have an on-chain security layer. The user account interface 262 can also generate a request to a suitable security platform 266, such as for example to a multiple signature platform, an example of which is the Gnosis Safe platform. The security platform 266 can be configured to require a selected or predefined number of signatures to confirm a transaction in order to execute the transaction. The security platform 266 can communicate with the smart contract 264. Specifically, the smart contract 264 can be coded to communicate with the security platform 266. The user account interface 262 can also be configured to integrate the smart contract wallet at a front-end level and at a backend level by linking it with a suitable API. The API can be deployed to automatically connect the interface 262 with the smart contract 264.

In the property tokenization system 260, the users can manage their assets, such as their real estate assets. For example, the users will be able to purchase tokens and resell them directly from the user account interface 262. The system can allow the user to directly use any balance in the smart contract wallet to buy new tokens or to ask to receive directly any income.

While the making and using of various embodiments of the present disclosure are discussed in detail herein, it should be appreciated that the present disclosure provides many applicable inventive concepts that are embodied in a wide variety of specific contexts. The specific embodiments discussed herein are merely illustrative of specific ways to make and use the disclosure and do not delimit the scope of the disclosure. Those of ordinary skill in the art will readily recognize numerous equivalents to the specific apparatuses, systems, and methods described herein. Such equivalents are within the scope of this disclosure and may be covered by the claims.

Furthermore, the features described herein in the various embodiments may be combined in any suitable manner in one or more embodiments. In the description contained herein, numerous specific details are provided, such as examples of programming, software, user selections, hardware, hardware circuits, hardware chips, or the like, to provide understanding of embodiments of the disclosure. One skilled in the relevant art will recognize, however, that the disclosure may be practiced without one or more of the specific details, or with other methods, components, materials, apparatuses, devices, systems, and so forth. In other instances, well-known structures, materials, or operations may not be shown or described in detail to avoid obscuring aspects of the disclosure.

The features and advantages of the embodiments of the present invention are apparent from the description and appended claims or may be learned by the practice of embodiments as set forth herein. As will be appreciated by one skilled in the art, aspects of the present disclosure may be embodied as an apparatus, system, method, computer program product, or the like. Accordingly, aspects of the present disclosure may take the form of an entirely hardware embodiment, an entirely software embodiment (including firmware, resident software, microcode, etc.) or an embodiment combining both software and hardware aspects that may all generally be referred to herein as a “circuit,” “module,” “unit” or “system.” Furthermore, aspects of the present disclosure may take the form of a computer program product embodied in one or more computer-readable media having program code embodied thereon.

In some embodiments, a module or unit may be implemented as a hardware circuit comprising custom (very large-scale integration) VLSI circuits or gate arrays, off-the-shelf semiconductors such as logic chips, transistors, or other discrete components. A module or unit may also be implemented in programmable hardware devices such as field programmable gate arrays, programmable array logic, programmable logic devices or the like.

Modules or units may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module or unit of program code may be a single instruction, or many instructions, and may even be distributed over several different code segments, among different programs, and across several memory devices. Similarly, operational data may be identified and illustrated herein within modules or units and may be embodied in any suitable form and organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more computer-readable media.

In some embodiments, a module or unit may include a smart contract hosted on a blockchain. The functionality of the smart contract may be executed by a node 14 (or peer) of the blockchain network 12. One or more inputs to the smart contract may be read or detected from one or more transactions stored on or referenced by the blockchain. The smart contract may output data based on the execution of the smart contract as one or more transactions to the blockchain. A smart contract may implement one or more methods or algorithms described herein.

The computer program product may include a computer-readable storage medium (or media) having computer-readable program instructions thereon for causing a processor to carry out aspects of the present disclosure. The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium may include a portable computer diskette, a random access memory (“RAM”), a read-only memory (“ROM”), an erasable programmable read-only memory (“EPROM” or Flash memory), a static random access memory (“SRAM”), a hard disk drive (“HDD”), a solid state drive, a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations or block diagrams of methods, apparatuses, systems, algorithms, or computer program products according to embodiments of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flow chart diagrams included herein are generally set forth as logical flow chart diagrams. As such, the depicted order and labeled steps are indicative of one embodiment of the presented method. Other steps and methods may be conceived that may be equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved, or may be executed in a different order. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

We claim:

1. A property tokenization system, comprising
a first blockchain network having a first blockchain and a first smart contract,
a tokenized real estate platform for tokenizing property to generate a plurality of ownership tokens in the property,
a plurality of user devices, and
a plurality of digital wallets associated with one or more of the plurality of user devices, the tokenized real estate platform, or the first blockchain network, wherein the plurality of digital wallets are configured for receiving and storing one or more of the plurality of ownership tokens.

2. The system of claim 1, wherein the plurality of ownership tokens corresponds to a real estate asset.

3. The system of claim 2, wherein the plurality of ownership tokens comprises a Ethereum Request for Comments 20 (ERC-20) compliant token.

4. The system of claim 2, wherein the plurality of ownership tokens comprise data restricting transfer of each of the plurality of ownership tokens to a predetermined user or a user in a predetermined jurisdiction.

5. The system of claim 2, wherein the tokenized real estate platform is configured to receive and distribute rental income associated with the property in the form of cryptocurrency to a user after an elapse of a predetermined amount of time in proportion to an amount of ownership tokens owned by the user.

6. The system of claim 1, wherein the tokenized real estate platform can be configured to receive and distribute rental income generated by the property in the form of cryptocurrency, further comprising
a second blockchain network having a second blockchain and a second smart contract that is configured for storing the plurality of ownership tokens and the rental income generated by the property associated with the plurality of ownership tokens,
a cross-chain network for facilitating communication between the first blockchain network and the second blockchain network,
a first liquidity pool for aggregating and storing assets from a plurality of users,
a property vault for storing one or more of the plurality of ownership tokens via the second smart contract, and
a rent vault for storing the rental income.

7. The system of claim 6, further comprising a token vault for identifying the holders of the plurality of ownership tokens via the second smart contract or for storing additional ones of the plurality of ownership tokens.

8. The system of claim 6, further comprising an off-chain network that communicates with the second smart contract of the second blockchain network to securely access data and services external to the second blockchain network.

9. The system of claim 8, wherein the off-chain network comprises a network of external digital agents for collecting and verifying data from various external data sources.

10. The system of claim 1, wherein the tokenized real estate platform can be configured to receive and distribute rental income generated by the property in the form of cryptocurrency, further comprising an operations layer for managing selected financial and insurance operations between one or more of the plurality of user devices and the tokenized real estate platform associated with the first blockchain network.

11. The system of claim 10, wherein the tokenized real estate platform comprises an insurance liquidity pool for aggregating funds for rental insurance and an investment liquidity pool for aggregating funds for investment.

12. The system of claim 11, wherein the funds are exchanged between the insurance liquidity pool and the investment liquidity pool.

13. The system of claim 12, wherein the insurance liquidity pool includes a low-risk reserve pool and a high-risk reserve pool, and wherein the rental insurance funds are selectively distributed therebetween based on one or more risk related attributes.

14. The system of claim 13, wherein the investment liquidity pool includes a low-risk investment pool and a high-risk investment pool, and wherein the rental insurance funds are selectively distributed therebetween based on one or more selected investment attributes.

15. The system of claim 14, wherein the operations layer comprises
a pricing model unit for applying one or more actuarial based pricing models to user provided insurance data to determine a cost of insurance based on a plurality of insurance related factors,
a loss assessment unit for determining a risk level of each of a plurality of portfolios of insurance products forming part of the insurance liquidity pool, and
a risk scoring unit for determining a risk score for each of the plurality of portfolios of insurance products.

16. The system of claim 15, wherein the risk scoring unit employs an Aggregate Loss Distribution (ALD) model to estimate an expected loss in each of the plurality of portfolios of insurance products.

17. The system of claim 16, wherein the ALD model includes
a frequency model for estimating a number of claims associated with the plurality of portfolios of insurance products that occur over a selected period of time based on one or more claim related factors, and
a severity model for estimating a monetary size of the claim by considering one or more loss related factors.

18. The system of claim 17, further comprising
a second blockchain network having a second blockchain and a second smart contract that is configured for storing the plurality of ownership tokens and the rental income generated by the property associated with the plurality of ownership tokens, and
a cross-chain network for facilitating communication between the first blockchain network and the second blockchain network.

19. The system of claim 18, further comprising an off-chain network that communicates with the second smart contract of the second blockchain network to securely access data and services external to the second blockchain network, wherein the off-chain network includes a network of external digital agents for collecting and verifying data from various external data sources.

20. The system of claim 19, further comprising a model layer that communicates with the tokenized real estate platform and with the first blockchain network so as to apply one or more modeling techniques to information stored in the tokenized real estate platform.

21. The system of claim 20, further comprising a governance unit that communicates with the operations layer to allow the users to perform one or more governance related activities.

22. The system of claim 1, wherein the ownership token includes metadata, wherein the metadata includes data, including identification information, associated with one or more of the plurality of ownership tokens, and wherein the identification information is configured to distinguish one of the plurality of ownership tokens from another one of the plurality of ownership tokens.

23. The system of claim 2, wherein the tokenized real estate platform can be configured to receive and distribute rental income generated by the property in the form of cryptocurrency, wherein the tokenized real estate platform is configured to distribute the rental income in response to an elapse of a predetermined amount of time.

24. The system of claim 1, wherein the first blockchain network employs a whitelisting technique that includes a list of selected properties, enterprises, or users that are granted permission to access the first blockchain network.

25. The system of claim 17, wherein the tokenized real estate platform comprises a SCR mining mechanism for dynamically adjusting a mining speed among the insurance liquidity pool and the investment liquidity pool according to a SCR ratio.

26. The system of claim 25, wherein one or more of the plurality of ownership tokens has an expense fee associated therewith, further comprising a governance unit for generating a plurality of governance tokens, wherein one or more of the governance tokens is issued by the governance unit to replace the expense fee, and the expense fee is removed from the ownership token.

27. A computer-implemented method for tokening property, comprising
providing a first blockchain network having a first blockchain and a first smart contract,
providing a tokenized real estate platform for tokenizing property to generate a plurality of ownership tokens in the property,
providing a plurality of digital wallets associated with one or more of a plurality of user devices, the tokenized real estate platform, or the first blockchain network, wherein the plurality of digital wallets are configured for receiving and storing one or more of the plurality of ownership tokens.

28. The computer-implemented method of claim 27, wherein the plurality of ownership tokens corresponds to a real estate asset.

29. The computer-implemented method of claim 28, further comprising restricting transfer of each of the plurality of ownership tokens to a predetermined user or to a user in a predetermined jurisdiction.

30. The computer-implemented method of claim 28, further comprising configuring the tokenized real estate platform to receive and distribute rental income associated with the property in the form of cryptocurrency to a user after an elapse of a predetermined amount of time in proportion to an amount of ownership tokens owned by the user.

31. The computer-implemented method of claim 27, wherein the tokenized real estate platform can be configured to receive and distribute rental income generated by the property in the form of cryptocurrency, further comprising
providing a second blockchain network having a second blockchain and a second smart contract that is configured for storing the plurality of ownership tokens and the rental income generated by the property associated with the plurality of ownership tokens,
providing a cross-chain network for facilitating communication between the first blockchain network and the second blockchain network,
forming a first liquidity pool for aggregating and storing assets from a plurality of users,
providing a property vault for storing one or more of the plurality of ownership tokens via the second smart contract, and
providing a rent vault for storing the rental income.

32. The computer-implemented method of claim 31, further comprising providing a token vault for identifying the holders of the plurality of ownership tokens via the second smart contract or for storing additional ones of the plurality of ownership tokens.

33. The computer-implemented method of claim 31, further comprising providing an off-chain network that communicates with the second smart contract of the second blockchain network to securely access data and services external to the second blockchain network.

34. The computer-implemented method of claim 33, further comprising providing a network of external digital agents for collecting and verifying data from various external data sources.

35. The computer-implemented method of claim 27, further comprising
configuring the tokenized real estate platform to receive and distribute rental income generated by the property in the form of cryptocurrency, and
providing an operations layer for managing selected financial and insurance operations between one or more of the plurality of user devices and the tokenized real estate platform associated with the first blockchain network.

36. The computer-implemented method of claim 35, further comprising configuring the tokenized real estate platform comprises to include an insurance liquidity pool for aggregating funds for rental insurance and an investment liquidity pool for aggregating funds for investment.

37. The computer-implemented method of claim 36, wherein the insurance liquidity pool includes a low-risk reserve pool and a high-risk reserve pool, and wherein the rental insurance funds are selectively distributed therebetween based on one or more risk related attributes.

38. The computer-implemented method of claim 37, wherein the investment liquidity pool includes a low-risk investment pool and a high-risk investment pool, and wherein the rental insurance funds are selectively distributed therebetween based on one or more selected investment attributes.

39. The computer-implemented method of claim 38, further comprising configuring the operations layer to include:
a pricing model unit for applying one or more actuarial based pricing models to user provided insurance data to determine a cost of insurance based on a plurality of insurance related factors,
a loss assessment unit for determining a risk level of each of a plurality of portfolios of insurance products forming part of the insurance liquidity pool, and
a risk scoring unit for determining a risk score for each of the plurality of portfolios of insurance products.

40. The computer-implemented method of claim 39, wherein the risk scoring unit employs an Aggregate Loss Distribution (ALD) model to estimate an expected loss in each of the plurality of portfolios of insurance products.

41. The computer-implemented method of claim 40, wherein the ALD model includes
a frequency model for estimating a number of claims associated with the plurality of portfolios of insurance products that occur over a selected period of time based on one or more claim related factors, and
a severity model for estimating a monetary size of the claim by considering one or more loss related factors.

42. The computer-implemented method of claim 41, further comprising providing
a second blockchain network having a second blockchain and a second smart contract that is configured for storing the plurality of ownership tokens and the rental income generated by the property associated with the plurality of ownership tokens, and
a cross-chain network for facilitating communication between the first blockchain network and the second blockchain network.

43. The computer-implemented method of claim 42, further comprising providing an off-chain network that communicates with the second smart contract of the second blockchain network to securely access data and services external to the second blockchain network, wherein the off-chain network includes a network of external digital agents for collecting and verifying data from various external data sources.

44. The computer-implemented method of claim 43, further comprising providing a model layer that communicates with the tokenized real estate platform and with the first blockchain network to apply one or more modeling techniques to information stored in the tokenized real estate platform.

45. The computer-implemented method of claim 44, further comprising providing a governance unit that communicates with the operations layer to allow the users to perform one or more governance related activities.

46. The computer-implemented method of claim 27, wherein the ownership token includes metadata, wherein the metadata includes data including identification information, associated with one or more of the plurality of ownership tokens, and wherein the identification information is configured to distinguish one of the plurality of ownership tokens from another one of the plurality of ownership tokens.

47. The computer-implemented method of claim 27, further comprising configuring the tokenized real estate platform to receive and distribute rental income generated by the property in the form of cryptocurrency and to distribute the rental income in response to an elapse of a predetermined amount of time.

48. The computer-implemented method of claim 27, wherein the first blockchain network employs a whitelisting technique that includes a list of selected properties, enterprises, or users that are granted permission to access the first blockchain network.

49. The computer-implemented method of claim 41, wherein the tokenized real estate platform comprises a SCR mining mechanism for dynamically adjusting a mining speed among the insurance liquidity pool and the investment liquidity pool according to a SCR ratio.

50. The computer-implemented method of claim 49, wherein one or more of the plurality of ownership tokens has an expense fee associated therewith, further comprising a governance unit for generating a plurality of governance tokens, wherein one or more of the governance tokens is issued by the governance unit to replace the expense fee, and the expense fee is removed from the ownership token.
